(19) United States
(12) Patent Application Publication
(10) Pub. No.: US 2002/0118832 A1
(43) Pub. Date: Aug. 29, 2002

(54) Contents processing method, contents processing system, recording device, execution device, central device, and computer memory product

(76) Inventors: Michio Matsuura, Kawasaki (JP); Keiji Shono, Kawasaki (JP); Kazuyuki Ozaki, Kawasaki (JP); Mineo Moribe, Kawasaki (JP); Motonobu Mihara, Kawasaki (JP); Koji Matsumoto, Kawasaki (JP); Seigo Kotani, Kawasaki (JP)

Correspondence Address: STAAS & HALSEY LLP, 700 11TH STREET, NW, SUITE 500, WASHINGTON, DC, 20001, US

(21) Appl. No.: 09/897,480

(22) Filed: Jul. 3, 2001

(30) Foreign Application Priority Data
Feb. 28, 2001 (JP) 2001-056052

(51) Int. Cl. H04N 7/167

(52) U.S. Cl. 380/201; 705/57

(57) ABSTRACT

The present invention is a system capable of protecting copyright and personal information appropriately and allowing users to readily obtain desired contents in a short time at low prices. A recording device stores contents in advance. The recording device encrypts the contents, based on an identifier given uniquely to a medium. The recording device records the encrypted contents on the medium. Moreover, the recording device records limiting conditions for reproducing, displaying or executing the contents on the medium. An execution device decrypts the contents recorded on the medium, based on the identifier. The execution device reproduces, displays or executes the contents under the limiting conditions recorded on the medium.

### BACKGROUND OF THE INVENTION

1. Field of the Invention

The present invention relates to a contents processing system for recording contents such as images, music, programs and web pages on a medium from a recording device and for reproducing, displaying or executing the contents recorded on the medium by an execution device of a user.

2. Description of the Prior Art

In recent years, there has been proposed a system for downloading, for pay, music, movies, games, etc. on a medium, such as an MO (Magnet-Optical Disk) and a DVD-RAM, possessed by a user from a recording device installed in a station, a convenience store, or other location.

Moreover, with establishment of high-speed communication networks, there have been proposed services for downloading music or images by using in-home computers. However, the use of the download services at home have not been spread because of problems related to security, communication costs and communication time, which occur at the stage of charging.

Although these problems would be solved as the communication speed is improved, the quantity of data tends to increase with the improvement of the communication speed. Therefore, it has been considered that a contents processing system that uses recording devices installed in public spaces other than homes would be spread in the future.

A technique disclosed in Japanese Laid-Open Patent Publication No. 11-143719/1999, for example, has been known as such a system. Japanese Laid-Open Patent Publication No. 11-143719/1999 discloses a download system for downloading music information, etc. from a server system connected to a downloading device or from the downloading device by inserting a medium into the downloading device. In this system, authentication of a user for charging is managed based on the user ID and password written in the medium.

Meanwhile, Japanese Laid-Open Patent Publication No. 8-223171/1996 discloses an information contents processing system in which an information selling machine stores information transmitted from newspaper publishing companies and a user inserts an IC card containing the user information into the information selling machine so as to obtain necessary information as electronic newspapers.

Furthermore, an illegal copy preventing technique is essential for recording of digital contents. Japanese Laid-Open Patent Publication No. 2000-285591 has been known as a technique for appropriately protecting copyright by preventing illegal copying. Japanese Laid-Open Patent Publication No. 2000-285591 discloses a contents processing system that stores purchased digital information by encrypting the digital information based on an ID given uniquely to a removable memory and reproduces music information while decrypting the information based on the ID during reproduction.

However, in the systems disclosed in Japanese Laid-Open Patent Publication Nos. 8-223171/1996 and 11-143719/1999, it is necessary to store personal information in a medium or an IC card in order to authenticate the user for charging. Registering the personal information is a troublesome work for the user.

In addition, there have been problems of leakage of personal information in recent years, and the management of the personal information is a heavy burden for shops.

Managing the rent history of information such as movies rented by a user causes a privacy problem. Besides, it is a troublesome work for the user to return the rented movie information.

The technique disclosed in Japanese Laid-Open Patent Publication No. 2000-285591 has succeeded in preventing illegal copying by using ID given uniquely to a removable memory. However, there has been a problem that this technique does not sufficiently use the characteristics of an identifier given uniquely to this medium.

Meanwhile, the number of distributed contents has been increasing. There is a limit to prepare in advance all contents in recording devices installed in convenience stores, stations, etc. because of memory capacity problems.

Further, it is a troublesome work for the user to select desired contents from an extremely large number of contents through the recording device. In this case, as disclosed in Japanese Laid-Open Patent Publication No. 11-143719/1999, there is a possibility of downloading desired contents consecutively via a download terminal from a server system that collectively stores the contents. However, suppose that the user uses the system at the station or other location in a short time, the user would be disgusted with a slow communication speed.

Moreover, at an ordinary home, browsing a web page is used a tool for obtaining information. However, it is still hard to say that this is a convenient tool because of the problems of communication speed and communication costs.

In short, there has been a demand for building a system capable of appropriately protecting copyright and personal information and allowing users to readily obtain desired contents in a short time at low prices.

### BRIEF SUMMARY OF THE INVENTION

The present invention was implemented in view of the above circumstances. The first object of the present invention is to provide a contents processing system that eliminates the need for managing personal information and is capable of protecting copyright appropriately and providing contents at low prices by storing limiting conditions for reproducing, displaying or executing contents in association with the encrypted contents.

The second object of the present invention is to provide a contents processing system capable of achieving a small-sized recording device and high-speed recording by specifying contents desired to be distributed through a central device in advance.

The third object of the present invention is to provide a contents processing system capable of allowing users to enjoy net surfing at low prices and in a short time by distributing web pages desired by the users as contents.

The fourth object of the present invention is to provide a contents processing system capable of limiting contents to be recorded on a medium within the storage capacity by adding a certain limitation on a web page desired by the user to distribute.

Recording devices installed in stations, convenience stores, etc., store contents in advance in conjunction with the first specifying information for specifying the contents. The user inserts a medium such as MO into a recording device. Then, the user selects a desired content (the first specifying information), such as a movie.

The selected first specifying information is accepted by the recording device. When the user pays for a fee for the content, the recording device reads an identifier given uniquely to the medium such as MO.

The recording device encrypts the content based on the read identifier. The recording device records the encrypted content on the medium. In this case, no personal information or the like is stored on the medium.

Therefore, the present invention enables the content to be obtained in a short time, such as within a time for waiting for a train at a station, without requiring a troublesome process of registering personal information.

Moreover, in the case where the user reproduces, displays or executes the contents on the medium at home by an execution device, the execution device reads the identifier of the medium. The execution device reproduces, displays or executes the contents while decrypting the encrypted contents based on the read identifier.

Hence, even if the encrypted contents are copied onto other medium, the contents can not be reproduced, displayed or executed because of a different identifier. Accordingly, the present invention can appropriately protect copyright.

Furthermore, the recording device accepts limiting conditions for reproducing, displaying or executing the contents. For example, the recording device accepts a given number of times of reproduction and a given reproduction period. The recording device records the accepted limiting condition information on the medium. The execution device of the user limits the reproduction, display or execution of contents based on the limiting conditions. For instance, the execution device does not execute a program when its execution period stored on the medium has expired.

Therefore, the present invention can build a business model of distributing various types of contents, which was not present in the past. For example, in the rent business such as video renting shops or the like, it is possible to establish an unmanned rent business that does not require the users to register their personal information nor return the contents and eliminates the need for personal expenses.

In other words, for the establishment of a content distributing business, it is necessary to totally improve the profits of content authors, protection of copyright, profits and convenience of users having distribution service, profits and easy management of distribution companies. The present invention prepares contents in advance, encrypts the contents based on a unique identifier of a medium, and records limiting conditions.

It is therefore possible to certainly protect the copyright of the content authors. The users can readily receive distribution in a short time at low prices without a risk of leakage of their personal information. The distribution companies are free from the burden of managing the personal information.

In addition, the central device of each distribution company is connected to the recording devices and the execution devices via communication networks. Each execution device accepts the first specifying information (for example, a movie title) for specifying a content desired by the user to distribute, and the second specifying information for specifying a recording device (for example, the identification code of the recording device, the mane of a station, convenience store, area or railway line or the like where the recording device is installed). Then, the execution device transmits to the central device the identifier of the medium inserted into the execution device, the first specifying information and the second specifying information.

The central device extracts a content corresponding to the transmitted first specifying information from a content database, based on the first specifying information. Then, the central device transmits the extracted content and the identifier to a recording device associated with the second specifying information.

The recording device stores the transmitted content and identifier in conjunction with each other. Then, when the user inserts the medium into the recording device, the recording device specifies the content by using the identifier as a key. The recording device encrypts the specified content based on the identifier of the medium and records the encrypted content.

Accordingly, there is no need to store all contents in the recording device beforehand, and it becomes possible to achieve small-sized equipment. Moreover, the users can record desired contents in a short time by the recording devices installed on their way to their office or school by specifying the desired contents at home or the like in advance.

Furthermore, the present invention distributes web pages as contents. The execution device transmits a search keyword as the first specifying information, the second specifying information and the identifier to the central device.

The central device performs searching using search engines. The central device downloads web pages corresponding to the search keyword and web pages linked to those web pages in the content database in conjunction with the identifier. Then, the central device extracts the web pages corresponding to the search keyword and web pages linked to those web pages from the content database.

The extracted web pages, i.e., the contents, are transmitted together with the identifier to a recording device associated with the second specifying information. The recording device stores the received web pages in a content file. Then, when the user inserts the medium into the recording device associated with the second specifying information, the recording device reads the identifier. The recording device records the web pages in the content file on the medium by using the read identifier as a key. The execution device reads the web pages recorded on the medium and displays them on a browser.

It is therefore possible to browse the web pages in an off-line state by the execution device and reduce the communication costs and the browsing time.

Moreover, the central device accepts a limit number of times for limiting the number of times of linking between the web pages corresponding to the search keyword and their linked web pages. In other words, when the central device tracks links of web pages corresponding to the search keyword, the number of web pages to be extracted increases in a chained manner. If the number of web pages to be recorded increases, there may arise a problem that the web pages exceed the storage capacity of the medium. Hence, the central device accepts a limit number of times, and extracts the web pages based on this limit number during extraction. It is therefore possible to prevent such a situation that the extracted information exceeding the storage capacity of the medium is transmitted to the recording device.

The above and further objects and features of the invention will more fully be apparent from the following detailed description with accompanying drawings.

### BRIEF DESCRIPTION OF THE SEVERAL VIEWS OF THE DRAWINGS

FIG. 1 is a schematic view showing an outline of a contents processing system of the present invention;

FIG. 2 is a block diagram showing the structure of a central device;

FIG. 3 is an explanatory view showing the data contents of a movie DB in a content database;

FIG. 4 is an explanatory view showing the data contents of a recording device management file;

FIG. 5 is a block diagram showing the structure of an execution device;

FIG. 6 is an explanatory view showing an image of specifying a content and a recording device;

FIG. 7 is a block diagram showing the structure of a recording device;

FIG. 8 is an explanatory view showing the data contents of a content file;

FIG. 9 is an explanatory view showing the data contents of a limiting condition table;

FIGS. 10A through 10F are flowcharts showing the processing procedure of a contents processing system according to the present invention;

FIG. 11 is a block diagram showing the structure of a central device according to Embodiment 2;

FIG. 12 is a block diagram showing the structure of a recording device of the present invention according to Embodiment 2;

FIG. 13 is an explanatory view showing the data contents of a web page DB;

FIGS. 14A through 14D are flowcharts showing the processing procedure of the present invention according to Embodiment 2; and

FIG. 15 is a schematic view showing an outline of the present invention according to Embodiment 3.

### DESCRIPTION OF THE PREFERRED EMBODIMENTS

Embodiment 1

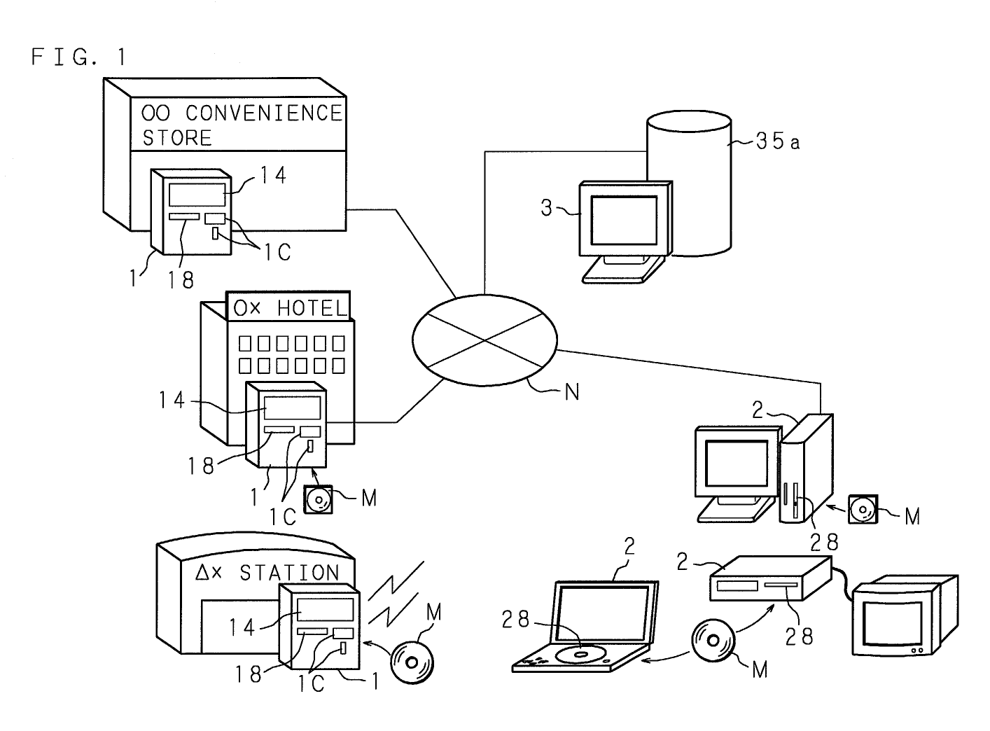

FIG. 1 is a schematic view showing an outline of a contents processing system of the present invention. In FIG. 1, numeral 3 is a central device for totally managing contents supplied by contents producers such as movie companies, music companies and game companies. The central device 3 is connected through a communication network N. The central device 3 stores the contents collected from the contents producers in a content database 35a.

These contents are transmitted to recording devices 1 connected to the central device 3 through the communication network N and installed in stations, convenience stores, hotels, airports, etc. Each recording device 1 stores the transmitted contents. The recording device 1 records the contents on a medium M, such as MO, DVD-RAM and smart media, inserted into a medium reader/writer 18.

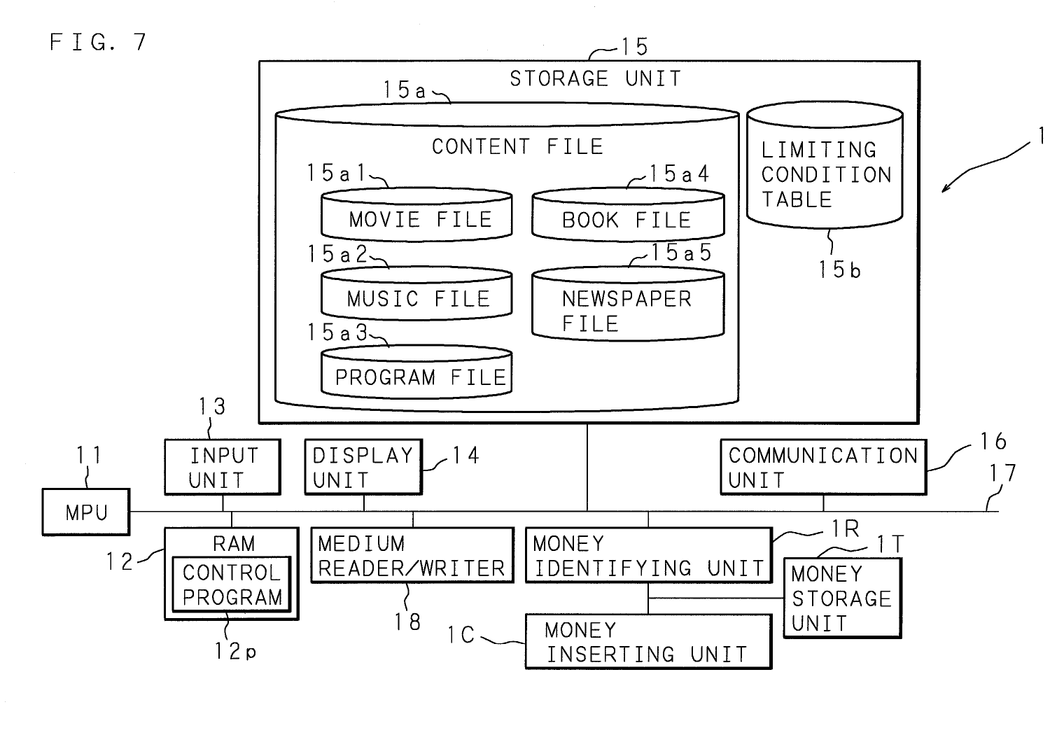

In this case, the user inputs the first specifying information (for example, a movie title) for specifying a content, i.e., a movie or the like desired to be recorded, from an input unit 13 (see FIG. 7). Moreover, the user pays the fee for the content through a money inserting unit 1C.

Each medium M is provided with a unique identifier for identifying the medium M. As the identifier, for example, it is possible to use one that is physically stored in the medium M, such as the production number of the medium M, or an identifier stored in a hidden file of the medium M.

Further, for recording of contents, if the medium M is MO, for example, it is desirable to write the contents by a ZCAV (Zoned Constant Angular Velocity) scheme using a multi head. Since the ZCAV scheme achieves a particularly high recording speed, the user can obtain the contents in a short time. Besides, in the case where the recording device 1 records the contents, the contents are recorded after being encrypted based on the identifier of the inserted medium M.

Execution devices 2 of users are connected to the communication network N. The execution devices 2 are, for example, personal computers, DVD players, portable DVD players or the like. It should be noted that the execution devices 2 are not necessarily connected to the communication network N. Each execution device 2 includes a medium reader/writer 28. When the medium M is inserted, the execution device 2 reproduces, displays or executes the contents while decrypting the encrypted contents based on the identifier of the medium M.

Note that, if limiting conditions on contents are stored on the medium M, the contents are reproduced, displayed or executed based on the limiting conditions.

In the case where the execution device 2 is connected to the communication network N, the user can access the central device 3 and specify contents desired to be distributed and a recording device 1 in which the contents are to be recorded. In this case, the execution device 2 transmits to the central device 3 the first specifying information for specifying contents, the second specifying information for specifying a recording device, and the identifier of the medium M. The central device 3 transmits the contents corresponding to the first specifying information and the identifier to the recording device 1 corresponding to the second specifying information. The recording device 1 stores the contents in conjunction with the identifier. When the user inserts the medium M into the medium reader/writer 18, the recording device 1 records the contents by using the identifier of the medium M as a key.

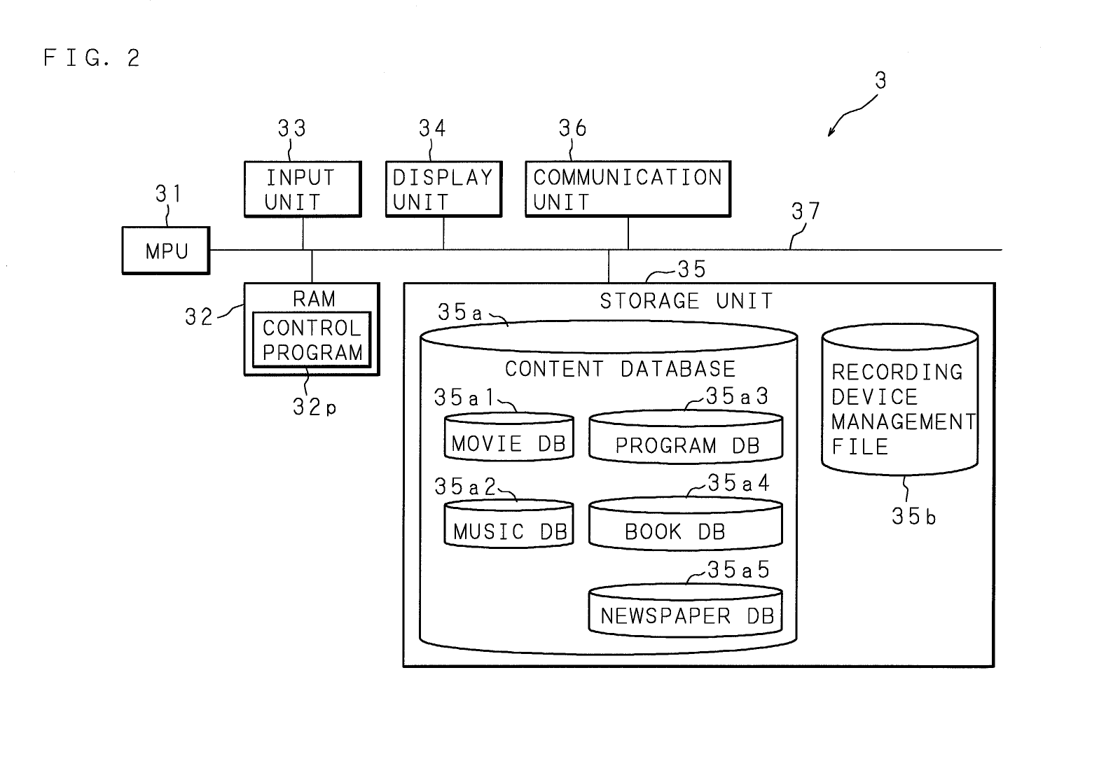

FIG. 2 is a block diagram showing the structure of the central device 3. As shown in FIG. 2, an MPU (Micro Processing Unit) 31 is connected through a bus 37 to a RAM 32, a storage unit 35 such as a hard disk, a communication unit 36 for transmitting and receiving information to/from the execution device 2 or the recording device 1, a display unit 34, and an input unit 33 such as a keyboard and a mouse.

The RAM 32 stores a control program 32p for controlling the storage unit 35, display unit 34, input unit 33, etc. The storage unit 35 includes a content database 35a. Contents purchased from movie companies, music companies, etc. are stored in the content database 35a. Note that the content database 35a is not necessarily provided in the central device 3. The content database 35a may be provided in other computer, not shown, connected through the communication network N.

The content database 35a stores a number of contents such as a movie DB 35a1 storing movie files, a music DB 35a2 storing music files, a program DB 35a3 storing software of games or the like, a book DB 35a4 storing electronic books, and a newspaper DB 35a5 storing electronic newspapers.

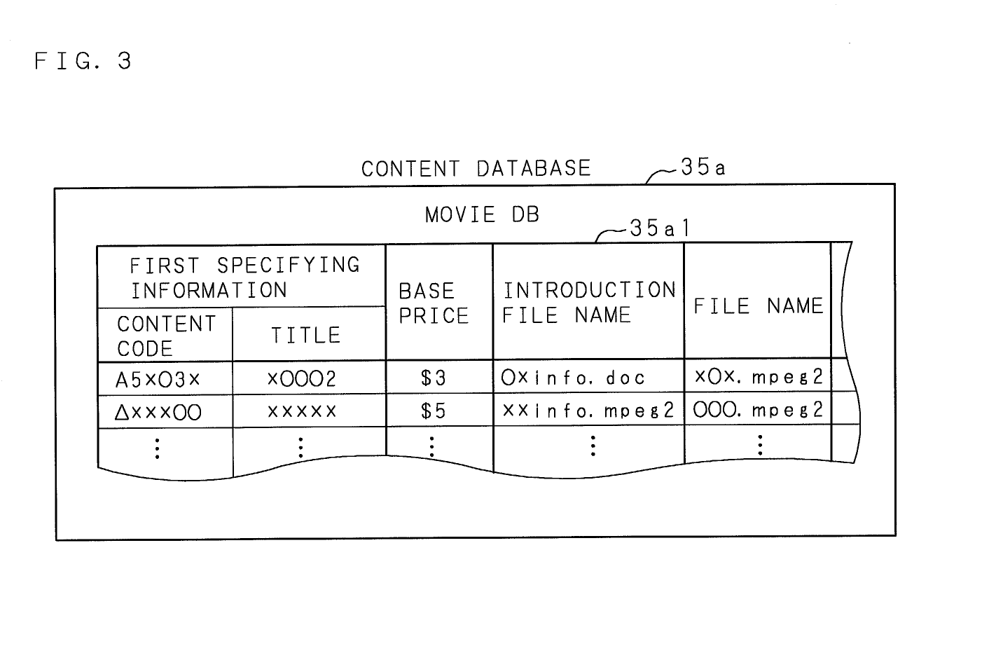

FIG. 3 is an explanatory view showing the data contents of the movie DB 35a1 in the content database 35a. As shown in FIG. 3, a base price, introduction file name and file name of a movie are stored in conjunction with the first specifying information, such as a content code or title given uniquely to each content for specifying the content such as a movie. Here, the base price is a price used as the basis when allowing users to record a content. The base price is multiplied by a value relative to the base price, which corresponds to a later-described limiting condition. For instance, an amount given by multiplying a base price by two is charged for a 1-week execution, and an amount given by multiplying a base price by one is charged for a 3-day execution.

Moreover, the introduction files are text files (the comments of movie critics, actors, story and so on) or image files (for example, digests and commercials) for introducing the contents. The introduction files aim for assisting users in judging whether to buy the contents. Note that the image files are stored in the form of MPEG-2 (Moving Picture Experts Group 2) or the like.

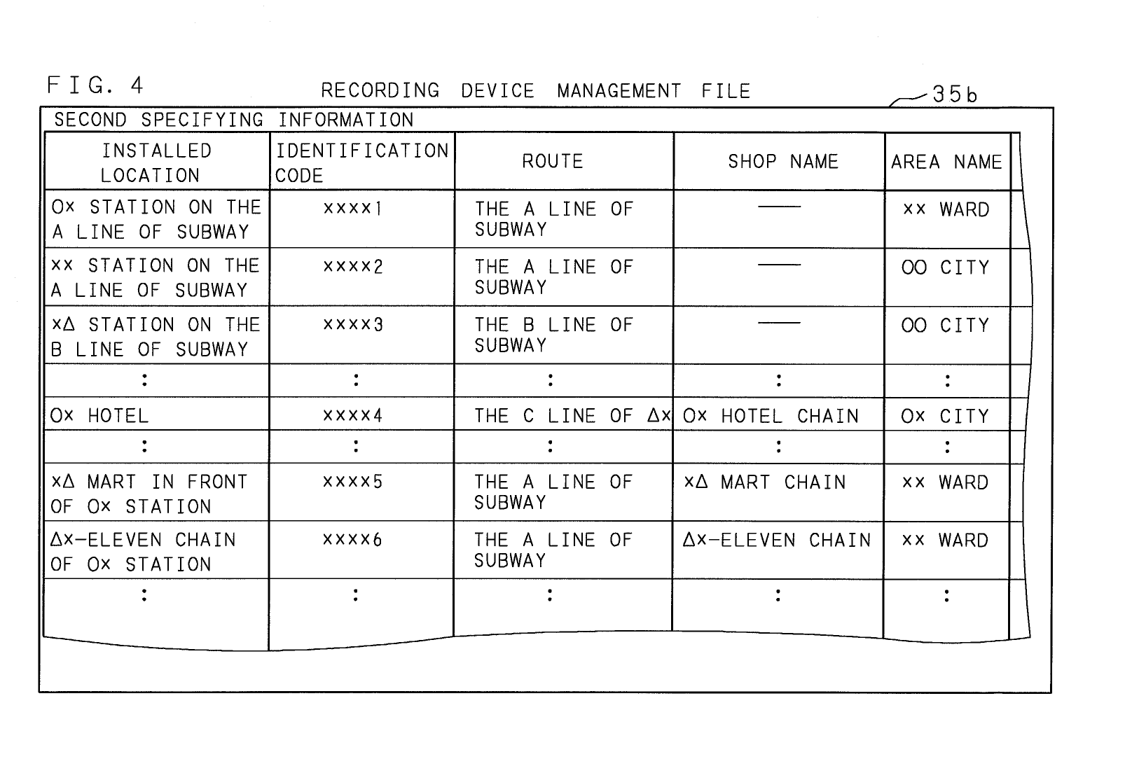

Furthermore, the storage unit 35 includes a recording device management file 35b. The recording device management file 35b stores information for managing the respective recording devices 1 installed in stations and other locations. FIG. 4 is an explanatory view showing the data contents of the recording device management file 35b. The recording device management file 35b stores the second specifying information for specifying the recording devices 1 in various forms as to be described later. As the second specifying information, unique identification codes for identifying the recording devices 1 and the installed locations are stored.

For instance, when a user tries to record contents at ox station on the A line of the subway on his or her way to work, the installed location information “ox station on the A line of the subway” or the identification code “xxxx1” is inputted in the execution device 2 and transmitted as the second specifying information from the execution device 2 to the central device 3. In this manner, the user can record necessary contents by the specified recording device 1.

Other examples of the second specifying information include a route, a shop name and an area name. If the user specifies a recording device 1 in only one location, there is a possibility that the specified recording device 1 is unavailable for some reason. Therefore, there is an option to arrange the execution device 2 to receive a wide range of specifying information, such as a route, a shop name and an area name, and allow the user to specify a plurality of recording devices 1. For instance, when “xx area” is specified for the area name as the second specifying information, the user can record contents by the recording devices 1 installed in “ox station on the A line of the subway”, “Δx mart in front of ox station” and “xΔ-eleven in front of ox station”. The recording device management file 35b stores the second specifying information in conjunction with the respective recording devices 1.

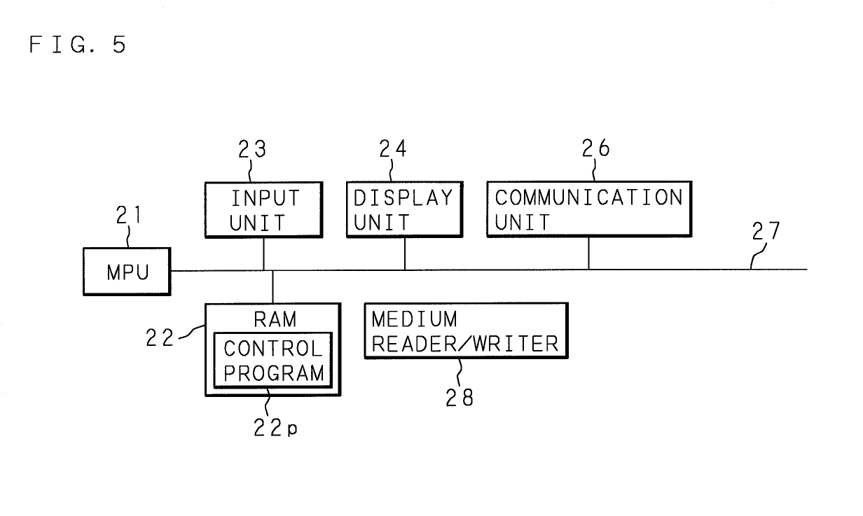

FIG. 5 is a block diagram showing the structure of the execution device 2. Note that while this embodiment illustrates the execution device 2 as a personal computer, the execution device 2 may be a DVD player, an MP3 layer or the like. As shown in FIG. 5, an MPU 21 is connected through a bus 27 to a RAM 22, a communication unit 26 such as a modem for transmitting and receiving information to/from the central device 3, a display unit 24 such as a liquid crystal display, and an input unit 23 such as a keyboard and a mouse. The RAM 22 stores a control program 22p for controlling the display unit 24, input unit 23, medium reader/writer 28, etc.

When the medium M on which contents are recorded is inserted into the medium reader/writer 28 of the execution device 2, the MPU 21 reads the encrypted contents and the identifier of the medium M. The MPU 21 stores in the RAM 22 the contents decrypted based on the read identifier. The MPU 21 reads the stored decrypted contents, and reproduces, displays or executes the contents. Note that, during reproduction, display or execution, the contents are reproduced, displayed or executed based on the limiting condition stored on the medium M, and this aspect will be described later.

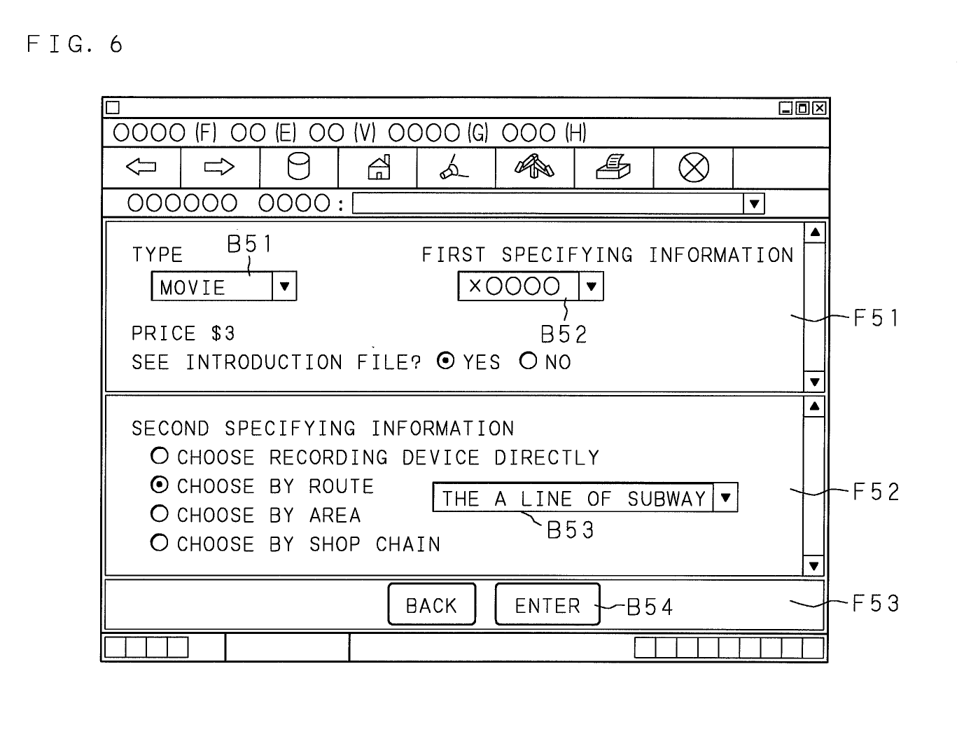

Besides, the execution device 2 can specify contents desired to be recorded and a recording device 1 in which the contents are to be recorded through the input unit 23. When the user inserts the medium M into the medium reader/writer 28 and inputs the URL of the central device 3 through the input unit 23, the URL and the identifier of the inserted medium M are transmitted to the central device 3. As a result, communications are established, and the screen shown in FIG. 6 is displayed on the display unit 24. FIG. 6 is an explanatory view showing an image of specifying contents and a recording device 1.

As shown in FIG. 6, a frame F51 of a browser includes a box B51 for specifying a type of content and a box B52 for specifying a content. The box B51 is a pull-down menu. The user can select a genre of contents such as movies, music, programs, electronic newspapers and books. On the other hand, in the box B52, the user can select the first specifying information for specifying a content from a pull-down menu.

The contents in the pull-down menu of the box B51 are embedded in a HTML (Hypertext Markup language) form beforehand. When the user specifies a genre in the box B51, the information is transmitted to the central device 3. The central device 3 transmits in the HTML form the information (for example, the movie title or content code) field (see FIG. 3) stored in the first specifying information of the DB stored in the content database 35a by using the transmitted genre information as a key. The transmitted information is displayed within the pull-down box B52.

When the first specifying information is specified, the execution device 2 transmits this information to the central device 3. The central device 3 extracts the base price and introduction file from the content database 35a by using the first specifying information as a key. The central device 3 transmits the extracted base price and introduction file to the execution device 2. As a result, the base price ($3 in FIG. 6) of the content is displayed in the frame F51. Besides, if the user wishes to see the introduction file, the MPU 21 reads the transmitted introduction file from the RAM 22 and executes the file.

In addition, the user can select the second specifying information from a frame F52. The user can select one recording device 1 directly or a plurality of recording devices 1 having a specific relation.

When the user selects “choose recording device directly” in the frame F52, the information is transmitted to the central device 3. The central device 3 transmits an installed location or identification code in the recording device management file 35b in the HTML form by using this information as a key. The transmitted installed location or identification code is displayed in a pull-down box B53.

Here, the user specifies one recording device 1 (the second specifying information). Then, when the user clicks an enter button B54 in a frame F53, the second specifying information, the first specifying information and the identifier are transmitted to the central device 3. Note that the central device 3 stores the transmitted information in the storage unit 35.

Further, when the user clicks “choose by route” in selecting the second specifying information in the frame F52, this information is transmitted to the central device 3. The central device 3 transmits the route information stored in the route field of the recording device management file 35b in HTML to the execution device 2 by using this information as a key. The transmitted information is displayed in the box B53. Then, when the user selects one route (the A line of the subway is selected in FIG. 6), the selected information is transmitted as the second specifying information. For instance, when the second specifying information “the A line of the subway” is transmitted to the central device 3, as shown in FIG. 4, a plurality of recording devices 1 corresponding to the A line of the subway (the identification codes “xxxx1”, “xxxx2”, “xxxx5” and “xxxx6” in FIG. 6) are selected. The user can record the desired contents from these plurality of recording devices 1.

FIG. 7 is a block diagram showing the structure of the recording device 1. The recording devices 1 are installed in facilities such as stations, convenience stores, hotels, department stores, super markets, schools, interchanges and airports. As shown in FIG. 7, an MPU 11 is connected through a bus 17 to a RAM 12, a communication unit 16 such as a modem for transmitting and receiving information to/from the central device 3, a display unit 14 such as a liquid crystal display, and an input unit 13 such as a keyboard. Note that the display unit 14 may be a touch panel.

In addition, the recording device 1 is provided with a medium reader/writer 18 for writing necessary information on a medium M, a money inserting unit 1C for accepting inserted money, a money storage unit 1T for storing money, and a money identifying unit 1R for judging whether money is genuine money. When money is inserted and it is judged genuine, a fee signal corresponding to the inserted money is outputted to the MPU 11. It should be noted that while money is used in this embodiment, it is possible to use prepaid cards or IC card on which monetary values are recorded.

In addition, the storage unit 15 such as a hard disk includes a content file 15a storing the contents transmitted from the central device 3 and a limiting condition table 15 in which limiting conditions are stored. Furthermore, the RAM 12 stores a control program 12p for controlling the display unit 14, input unit 13, medium reader/writer 18, etc.

The content file 15a further stores a number of contents such as a movie file 15a1, a music file 15a2, a program file 15a3, a book file 15a4 and a newspaper file 15a5 according to genres. These stored contents are periodically transmitted from the central device 3, and further, if the user specifies desired contents through the execution device 2, the contents are stored.

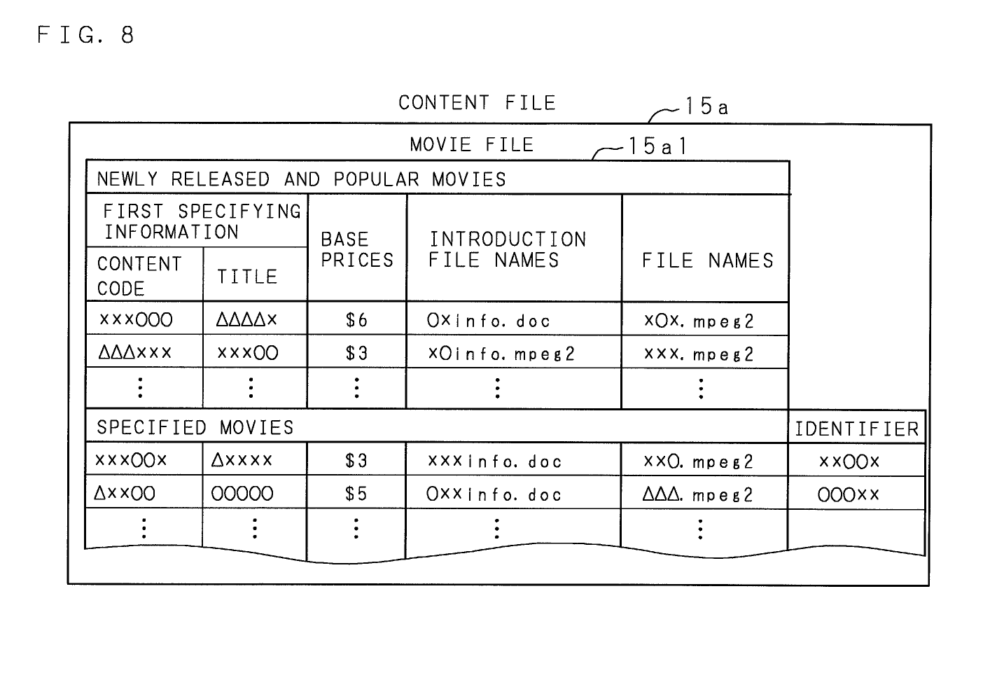

Contents in great demand, such as newly released movies, movies being the talk of the town and movies which have been popular for a long time, are transmitted to the recording devices 1 in advance. FIG. 8 is an explanatory view showing the data contents of the content file 15a. As shown in FIG. 8, the first specifying information such as the titles and content codes for specifying contents, base prices, introduction file names and content file names are stored in the field of newly released and popular movies.

When the user selects a title through the input unit 13, the recording device 1 reads the identifier of the medium M in the medium reader/writer 18. The recording device 1 encrypts the content associated with the title selected based on the read identifier. Then, the recording device 1 writes the encrypted content on the medium M.

The recording device 1 ejects this medium M on condition of payment of a predetermined fee. It should be noted that the recording device 1 may read the introduction file in the content file 15a and show a sample screen on the display unit 14.

On the other hand, when the user specifies the first specifying information and the second specifying information through the execution device 2, the central device 3 extracts a content from the content database 35a by using the first specifying information as a key. The central device 3 transmits the identifier, the content, etc. to the recording device 1 corresponding to the specified second specifying information.

Then, as shown in the specified movie field of FIG. 8, the recording device 1 stores the content in conjunction with the transmitted identifier. Here, when the user inserts the medium M, the MPU 11 reads the identifier of the medium M and extracts the content by using this identifier as a key. The recording device 1 encrypts the content and writes the encrypted content on the medium M. Note that the recording device 1 may stock the medium M and sells the medium M on condition of insertion of a predetermined amount of money.

The recording device 1 records not only the encrypted contents, but also records the limiting conditions stored in the limiting condition table 15b on the medium M. This will be explained in detail below.

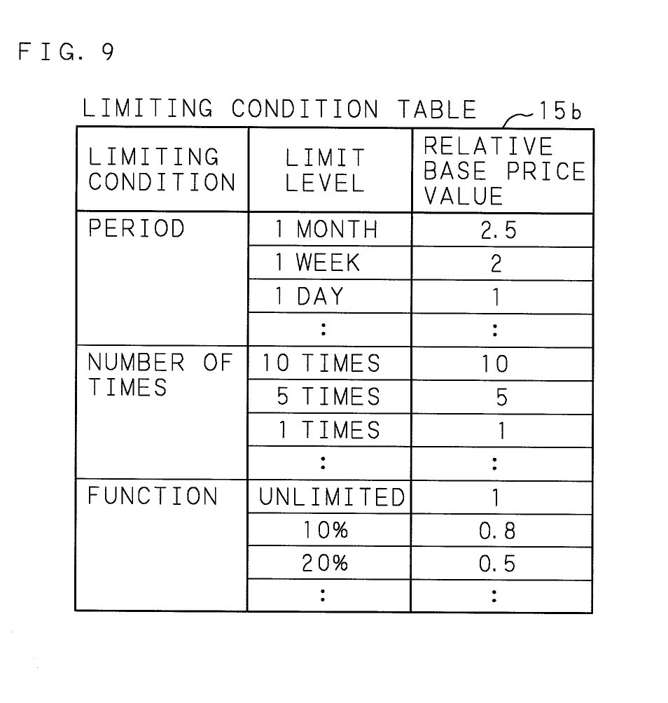

The limiting conditions refer to conditions that limit reproduction, display or execution of contents. Examples of such conditions are the period, the number of times and the functions that limit reproduction, display or execution of contents. FIG. 9 is an explanatory view showing the data contents of the limiting condition table 15b. As shown in FIG. 9, the period, the number of times, the functions and so on are stored as the limiting conditions. The period refers to a period determined as a condition within which the user can reproduce, display or execute a content.

For a limit level, as shown in the limit level field, information such as “1 month”, “1 week” or “1 day” is stored as table data. Moreover, a relative base price value field is provided in conjunction with the limit level field, and “2.5 times”, “2 times” and “1 time” are stored for “1 month”, “1 week” and “1 day”, respectively.

In other words, the present invention sets that the selling price is raised from the base price as the period of allowing reproduction, display or execution of content becomes longer. For example, in the case where the base price of a movie content is $3, the selling price is $3 when reproduction is allowed for only one day, and the selling price is doubled to $6 when reproduction is allowed for one week. Thus, the present invention can set the prices according to the rent periods. Moreover, unlike conventional video renting shops, even if contents are rented for a long period of one month, it is possible to sell the contents themselves unlimitedly. Therefore, the present invention can prevent a decrease of the rent rate due to rented contents and can lower the prices as compared with a conventional system, thereby promoting demand. Furthermore, if there is a great demand, such an effect would be produced that cooperation of a copyright organization which has negative opinion about growing of video renting shops is likely obtained.

As other limiting conditions, there is a limitation on the number of times or a limitation on the program functions. The “number of times” in the limiting condition field refers to a limiting condition that limits the number of times of allowing reproduction, display or execution of a content. As stored in the limit level field, some numbers are stored for the number of times of allowing execution of content as table data. Additionally, relative base price values are stored correspondingly.

A limiting condition “function” is a condition of limiting the functions of a program. Limit levels are stored in the limit level field. For example, a program having 100% of its functions can be recorded and executed when “unlimited” is set as the condition. It should be noted in this case that a high price of payment is of course set for the base price.

On the other hand, if the limit level is “10%” as for a trial version of software, the recording device 1 may be designed to record the program from which 10% of its functions are deleted. For example, the recording device 1 records the program by deleting 10% of the plug-in functions so as to limit the deleted plug-in functions.

On the contrary, the recording device 1 records the program having 100% of its functions, and further stores a limit level “20%” on the medium M. Accordingly, when the execution device 2 executes the program, 20% of the plug-in functions are not executable. In this case, the fee to be paid is discounted by 20% of the base price.

Specific contents of processing will be explained. The user inserts the medium M into the medium reader/writer 18. The user selects a necessary content (the first specifying information) and a limit level of a limiting condition. For instance, if the user selects “period: 1 week” as the limiting condition and limit level, this information is accepted. The MPU 11 reads a relative base price value (2 times) corresponding to this information from the limiting condition table 15b by using this limiting condition as a key, and stores it in the RAM 12.

Then, the recording device 1 reads a base price from the content file 15a by using the first specifying information as a key, and calculates a selling price by multiplying the base price by the relative base price value stored in the RAM 12. The calculated selling price is displayed on the display unit 14. In this case, the recording device 1 may read the introduction file from the content file 15a and display it on the display unit 14. In this manner, it is possible to increase the customer's interest to buy the content.

When the user inserts money equivalent to the selling price into the money inserting unit 1C, the fee information corresponding to the fee is outputted from the money identifying unit 1R, and the MPU 11 accepts the outputted fee information. The recording device 1 reads the content from the content file 15a, encrypts the content based on the identifier of the medium M, and stores the encrypted content in the RAM 12.

Besides, the recording device 1 reads the stored encrypted content, and instructs the medium reader/writer 18 to write the read encrypted content on the medium M. Additionally, the recording device 1 records the accepted limiting condition. For example, if the limiting condition is the “period”, then the recording device 1 records the due date. If the limiting condition is “number of times”, then the recording device 1 records a given number of times. Further, if the limiting condition is “function”, then the recording device deletes a part of the plug-in functions.

Alternatively, the recording device 1 may record a program whose functions are not limited and its limit level (for example, 10%). In this case, the recording device 1 may record the date of recording the limiting condition on the medium M.

The identifier is read from the medium M inserted into the medium reader/writer 28 of the execution device 2. The execution device 2 decrypts the content based on the read identifier. At this time, the execution device 2 reads the limiting condition recorded on the medium M and stores it in the RAM 22. Then, the MPU 21 reproduces, displays or executes the decrypted content based on the stored limiting condition.

For instance, if the limiting condition is “period: 1 week”, the execution device 2 compares the due date recorded on the medium M with the date outputted from a clock unit, not shown, of the execution device 2. If the due date has expired as a result of the comparison, the execution device 2 prohibits reproduction, display or execution. Moreover, if the number of times is selected as a limiting condition, the MPU 21 decrements one from the number of times whenever reproduction, display or execution is performed, and prohibits execution when the number of times becomes “0”.

Further, if “function” is selected as a limiting condition, the MPU 21 of the execution device 2 executes a program whose functions are limited. Note that, when the functions are limited, the recording device 1 may record contents whose functions have been limited in advance during recording. Alternatively, it is possible that the recording device 1 records 100% of the functions in recording a program and the execution device 2 limits a part of the plug-in functions in executing the program. In the latter case, if the user likes the trial version of software with the limited functions and decides to purchase the proper version of software (with no limitation on the functions), then the execution device 2 accesses the central device 3. The execution device 2 rewrites the stored limiting condition. In this manner, it is possible to make all the plug-in functions executable.

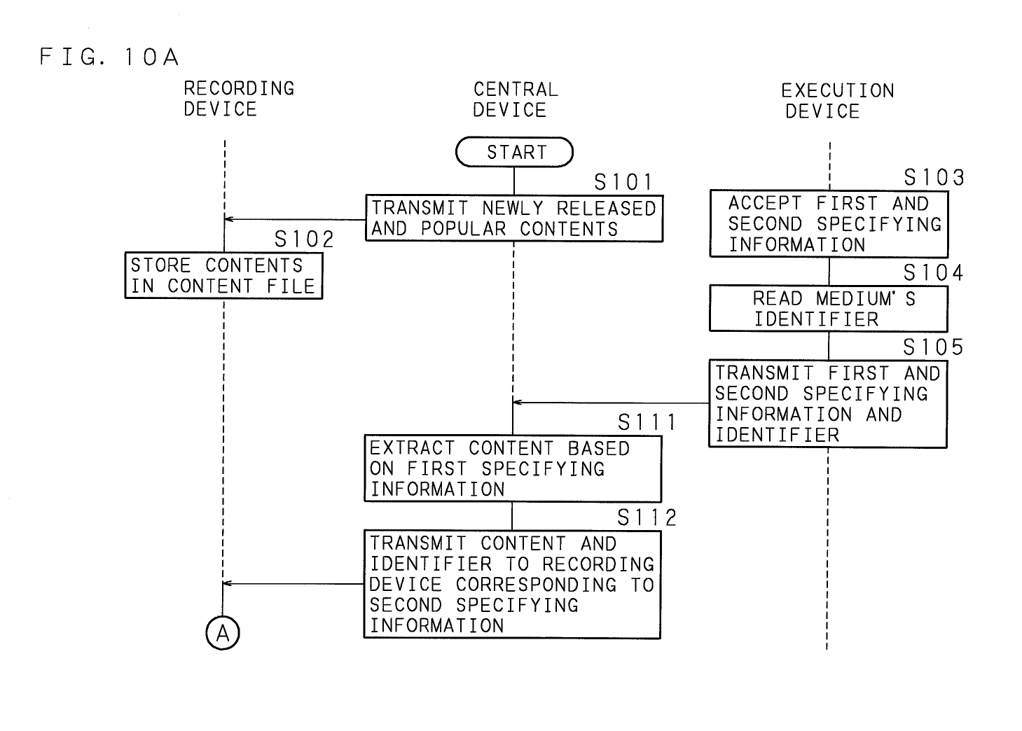

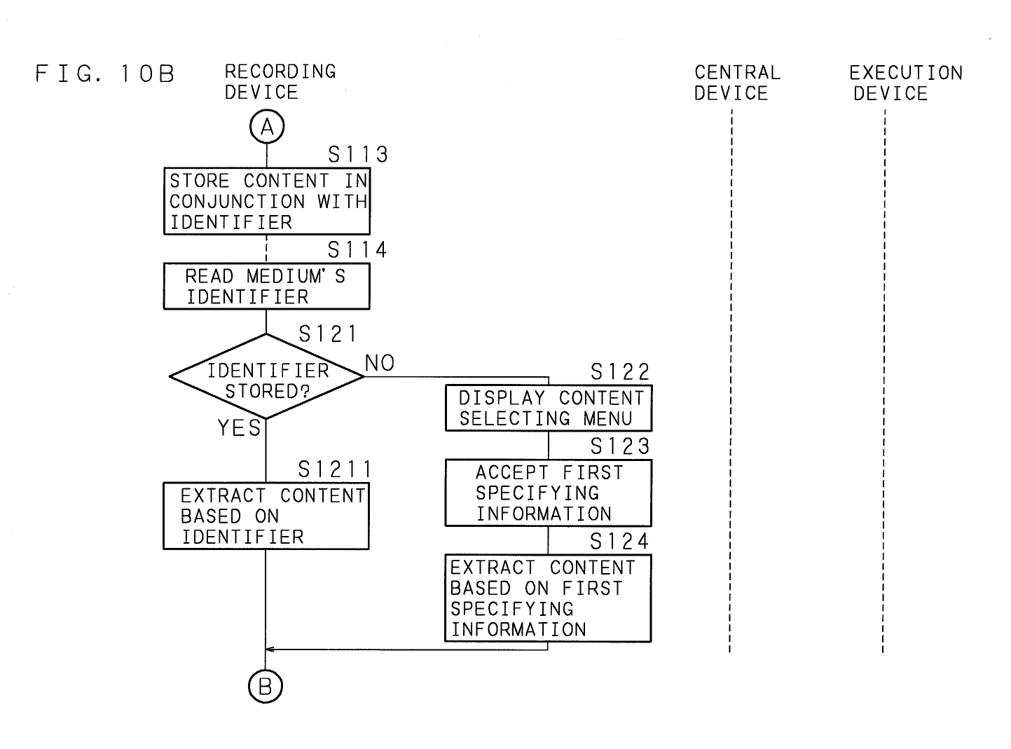

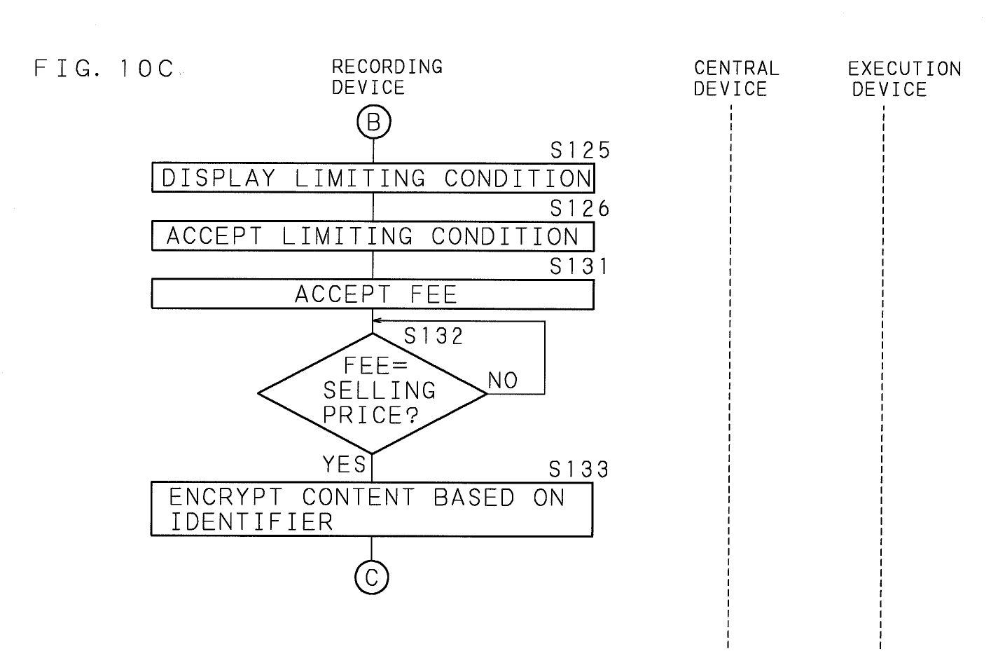

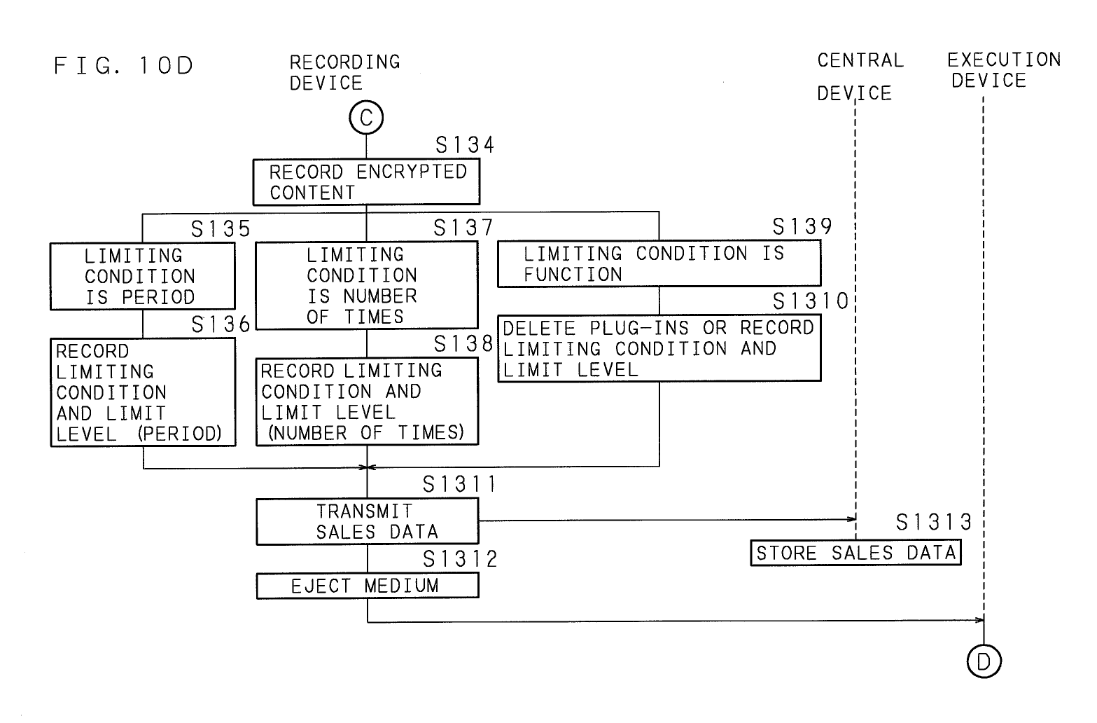

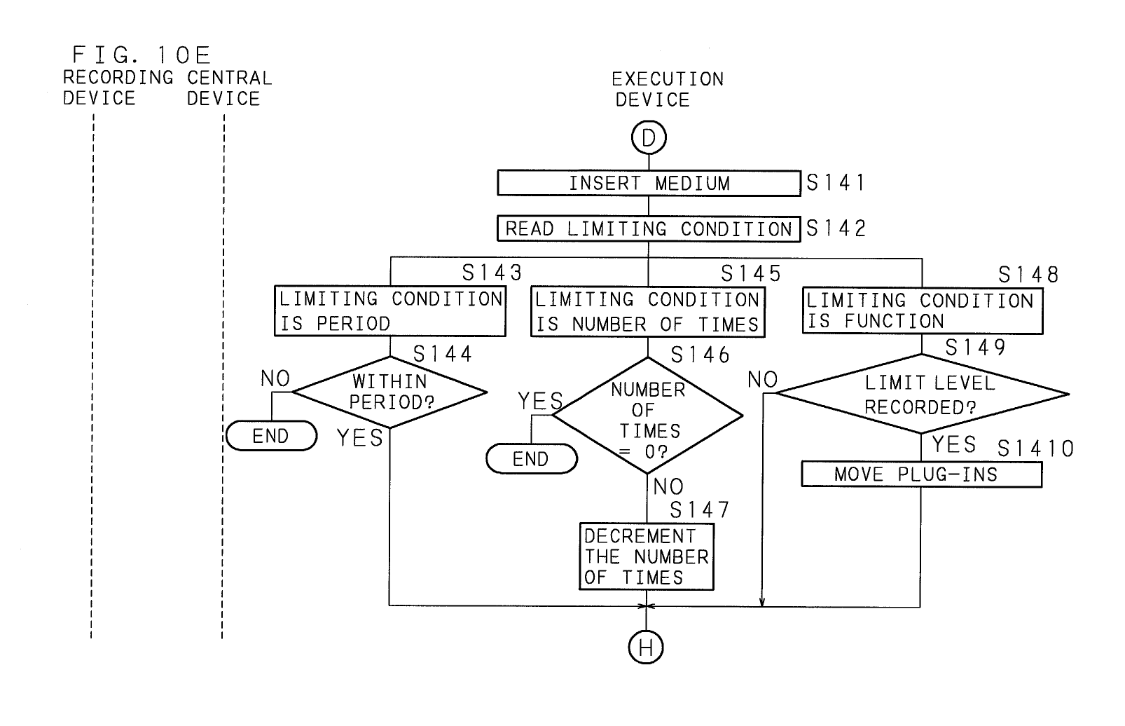

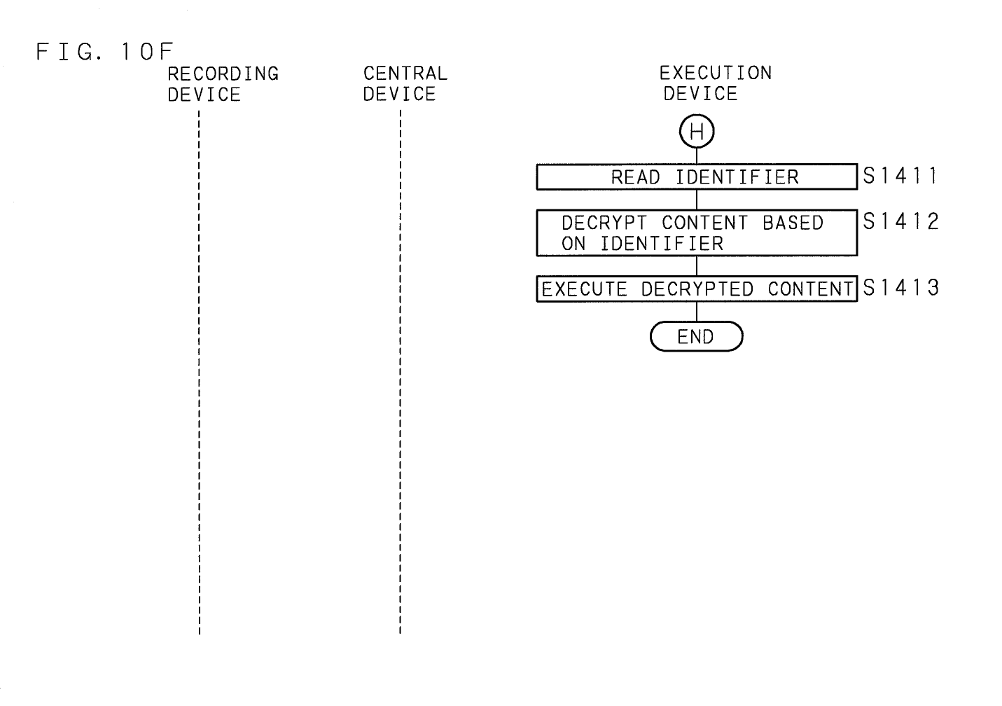

FIGS. 10A through 10F are flowcharts showing the processing procedure of a contents processing system according to the present invention. First, the central device 3 reads contents specified through the input unit 33 of the central device 3 from the content database 35a. The central device 3 transmits the read contents to all the recording devices 1 (step S101). The contents to be transmitted are newly released or popular contents. The recording devices 1 store the transmitted contents in their content file 15a (step S102). Consequently, specific contents are prepared in the recording devices 1 in advance.

The following description will explain how the user specifies contents desired to be distributed from the execution device 2 beforehand. First, as shown in FIG. 6, the user inputs the first specifying information for specifying a content desired to be distributed and the second specifying information for specifying a recording device 1 to which the content is to be distributed. The first specifying information and second specifying information inputted to a browser are accepted (step S103) and stored in the RAM 22. Then, the execution device 2 reads the identifier of the medium M inserted into the medium reader/writer 28 (step s104). The execution device 2 transmits the read identifier, the first specifying information and second specifying information stored in the RAM 22 to the central device 3 (step S105).

The central device 3 extracts the corresponding content from the content database 35a by using the transmitted first specifying information as a key (step S111). Then, the central device 3 transmits the extracted content and identifier to the recording device 1 corresponding to the transmitted second specifying information (step S112).

More specifically, the central device 3 searches the recording device management file 35b by using the transmitted second specifying information as a key, and extracts one or a plurality of corresponding recording devices 1. For instance, as shown in FIG. 4, if the second specifying information is “xx area”, then “ox station on the A line of the subway”, “Δx mart in front of ox station” and “xΔ-eleven in front of ox station” are extracted as the recording devices 1 to which the content is to be transmitted. Moreover, the central device 3 may extract the base price and introduction file corresponding to the content to be transmitted from the content database 35a, and transmits them to the recording devices 1 together with the content.

The recording device 1 stores the content, the base price, the introduction file and so on in the content file 15a in conjunction with the transmitted identifier (step S113). Here, if the user inserts the medium M into the medium reader/writer 18 to purchase the content, the MPU 11 reads the identifier of the medium M (step S114). The MPU 11 searches the content file 15a by using the read identifier as a key, and judges whether the identifier is stored in the content file 15a (step S121). If the identifier is not stored (NO in step S121), the MPU 11 displays a content selecting menu on the display unit 14 (step S122).

More specifically, the MPU 11 reads the titles, base prices, introduction files, etc. of contents stored as newly released and popular contents from the content file 15a. Then, the MPU 11 displays the read contents on the display unit 14. Here, if the user selects the first specifying information for specifying a content desired to be recorded through the input unit 13, the MPU 11 accepts this information (step S123). The MPU 11 extracts the content and base price corresponding to the accepted first specifying information from the content file 15a (step S124). The MPU 11 stores the extracted content and base price in the RAM 12.

On the other hand, when the identifier of the medium M is stored in the content file 15a (YES in step S121), the recording device 1 extracts the content and base price from the content file 15a by using the identifier as a key (step S1211) and stores them in the RAM 12.

Subsequently, the recording device 1 reads a limiting condition, etc. from the limiting condition table 15b. The recording device 1 displays the contents of the limiting condition on the display unit 14 (step S125). As the displayed contents, the limiting condition, the limit level of the limiting condition, and the selling price given by multiplying the base price stored in the RAM 12 by a relative base price value are displayed. The selling price is calculated by multiplying the base price stored in the RAM 12 by the relative base price value stored in the corresponding base value field of the limiting condition table 15b. Here, if the user selects a limiting condition and its limit level through the input unit 13, the recording device 1 accepts the selected limiting condition and limit level (step S126).

Next, the recording device 1 accepts the inserted fee (step S131). The recording device 1 judges whether the inserted fee is equal to the selling price (step S132). If the inserted fee is less than the selling price (NO in step S132), the recording device 1 repeats this process. When a fee equal to the selling price is inserted (YES in step S132), the recording device 1 encrypts the content stored in the RAM 12 based on the identifier of the medium M (step S133).

The recording device 1 records the encrypted content on the medium M (step S134). Moreover, the recording device 1 records the accepted limiting condition on the medium M (steps S135 through S1310).

Further, the recording process branches according to the type of limiting condition. If the limiting condition is the period and the limiting condition and its limit level are “period and limit level of 1 week” (step S135), then the recording device 1 records the date of one week after the current date, or records the current date and the information of one week (step S136).

Besides, if the limiting condition and its limit level is “number of times and limit level of 5 times” (step S137), then the recording device 1 records the number of times (for example, “5 times”) as the limiting condition and the limit level (step S138).

Furthermore, if the limiting condition and its limit level is “function and limit level of 50%” (step S139), then the recording device 1 deletes about a half of the plug-ins of the recorded program (step S1310). Alternatively, the recording device 1 records the program with 100% of its functions and the ratio of plug-in functions which are to be limited (for example, “50%”) as the limiting condition and the limit level.

Subsequently, the recording device 1 transmits sales data such as the selling price and the first specifying information of the recorded content to the central device 3 (step S1311). The central device 3 stores the sales data in the storage unit 35 (step S1313). Thereafter, the medium M is ejected from the medium reader/writer 18 (step S1312).

Next, the following description will explain the process of reproducing, displaying or executing the content when the user brings the medium M to his or her home or the like. When the user inserts the medium M (step S141), the execution device 2 first reads the limiting condition recorded on the medium M (step S141). Then, according to the read limiting condition, the process branches as follows.

First, when if the limiting condition is “period” (step S143), then the execution device 2 first judges whether the limiting condition has not expired (step S144). More specifically, the execution device 2 compares the current date outputted from the clock unit, not shown, with the date recorded on the medium M. Then, the execution device 2 judges whether the period has expired. Alternatively, the execution device 2 may compare a date given by adding the period to the date of storing the content on the medium M with the current date. When the period has expired (NO in step S144), the execution device 2 ejects the medium M and completes the process.

Besides, if “number of times” is recorded as a limiting condition (step S145), then the execution device 2 judges whether the recorded number of times is “0” (step S146). When the number of times is “0” (YES in step S146), the execution device 2 ejects the medium M and completes the process. On the other hand, when the number of times is not “0”, the execution device 2 decrements one from the number of times of recording (step S147).

Further, if the limiting condition is “function” (step S147), then the execution device 2 judges whether a limit level is recorded on the medium M (step S149). When the limit level is recorded (YES in step S149), the execution device 2 moves a proportion of plug-ins corresponding to the limit level into another hidden file. Then, the execution device 2 makes the moved plug-in functions infeasible (step S1410). On the other hand, when the limit level is not recorded (NO in step S149), the execution device 2 skips the process of step S1410 so as to permit execution according to the recorded contents.

When the limiting conditions are satisfied, i.e., when the current date is within the specified period in step S144 (YES in step S144), when decrement of the number of times is performed (step S147) and when the limiting condition is the function and its limit level is not recorded (NO in step S149) or when plug-in functions are moved into a hidden folder due to a limitation on the functions (step S1410), the execution device 2 reads the identifier of the medium M (step S1411). The execution device 2 decrypts the encrypted content based on this identifier and stores it in the RAM 22 (step S1412). Then, the execution device 2 reproduces, displays or executes the decrypted content (step S1413).

With such a structure, reproduction, display or execution of content corresponding to the amount paid by the user is permitted. Thereafter, reproduction, display or execution is infeasible. Accordingly, the sellers can provide contents at costs lower than ordinary costs, thereby promoting the demands.

Moreover, since there is no need to return the contents, it is not necessary to register individuals. Furthermore, it is also possible to eliminate the need for placing sales persons in shops where the recording devices 1 are installed.

Besides, if the limiting condition is the function and the user wishes to upgrade the trial version program to the program with its complete functions, then the user accesses the central device 3 and performs a predetermined charging process. Then, the central device 3 distributes to the execution device 2 an EXE file for moving the plug-ins in the hidden file to the original medium M. The user executes this distributed EXE file. Consequently, the user can use the plug-ins which were unavailable until then and can execute the program having no limitation on its functions.

Embodiment 2

In addition to Embodiment 1, Embodiment 2 relates to a system for distributing web pages as contents.

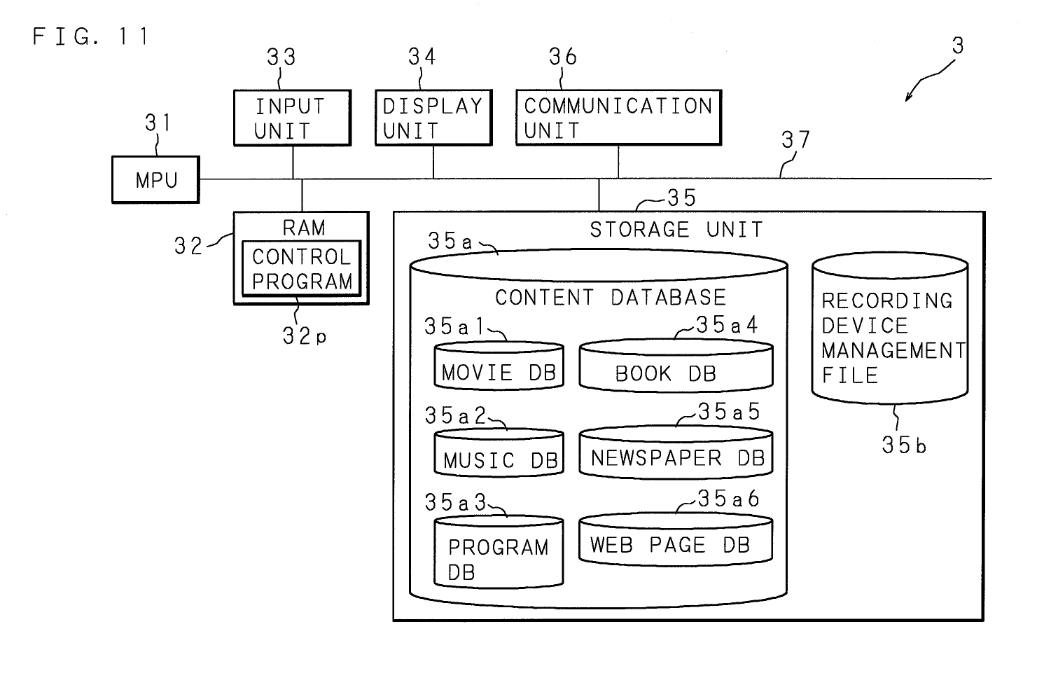

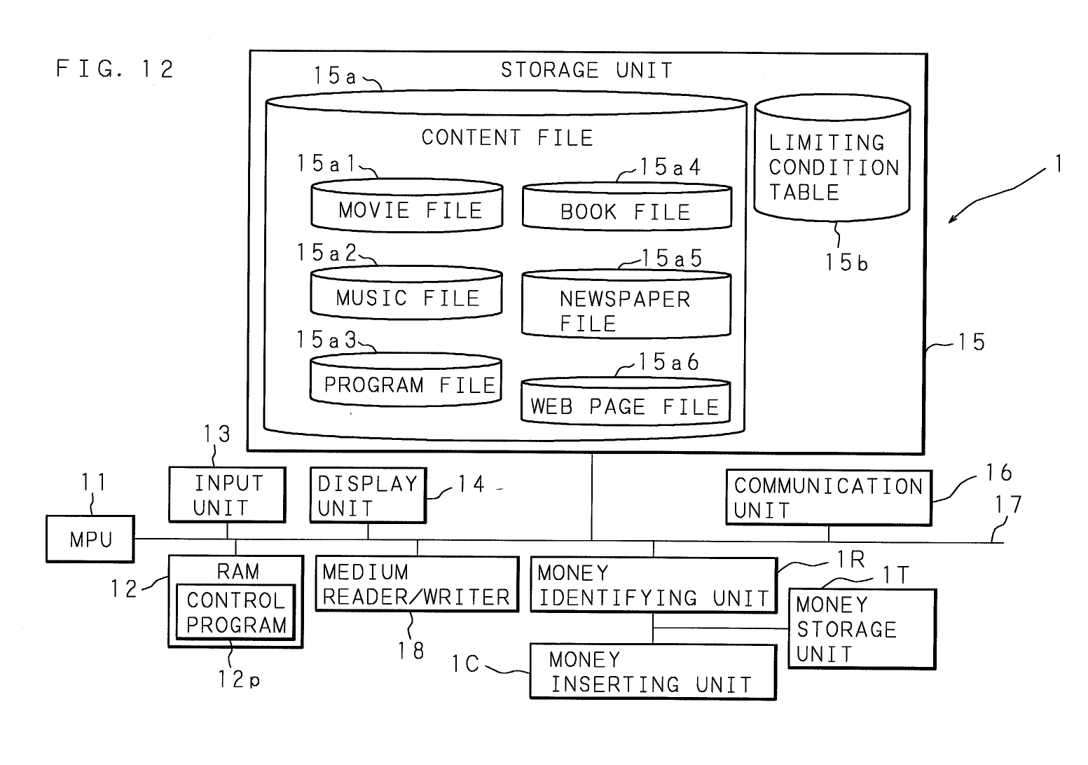

FIG. 11 is a block diagram showing the structure of the central device 3 according to Embodiment 2. As shown in FIG. 11, the content database 35a includes a wave page DB 35a6. Moreover, FIG. 12 is a block diagram showing the structure of the recording device 1 of the present invention according to Embodiment 2. A web page file 15a6 is stored in the content file 15a.

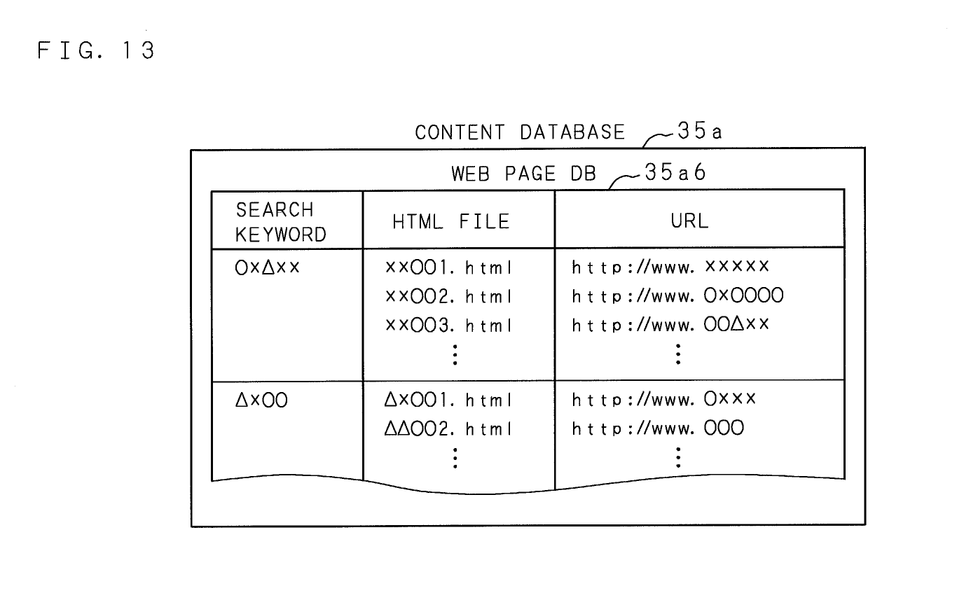

FIG. 13 is an explanatory view showing the data contents of the web page DB 35a6. In the web page DB 35a6, HTML files containing a description of an outline of web pages and links for accessing the web pages and further the URLs of the web pages are stored in advance in conjunction with a search keyword.

When a search keyword for searching web pages is inputted by the user through the input unit 23 of the execution device 2 and transmitted to the central device 3, the central device 3 transmits the search results to the execution device 3 by a technique similar to that used in known search engines. More specifically, the central device 3 reads an HTML file corresponding to the search keyword from the web page DB 35a6 and transmits it to the execution device 2. When the user clicks a link in the transmitted HTML file, the execution device 2 is connected to a server computer corresponding to the URL described in a tag of the HTML document. This enables the execution device 2 to browse the web page.

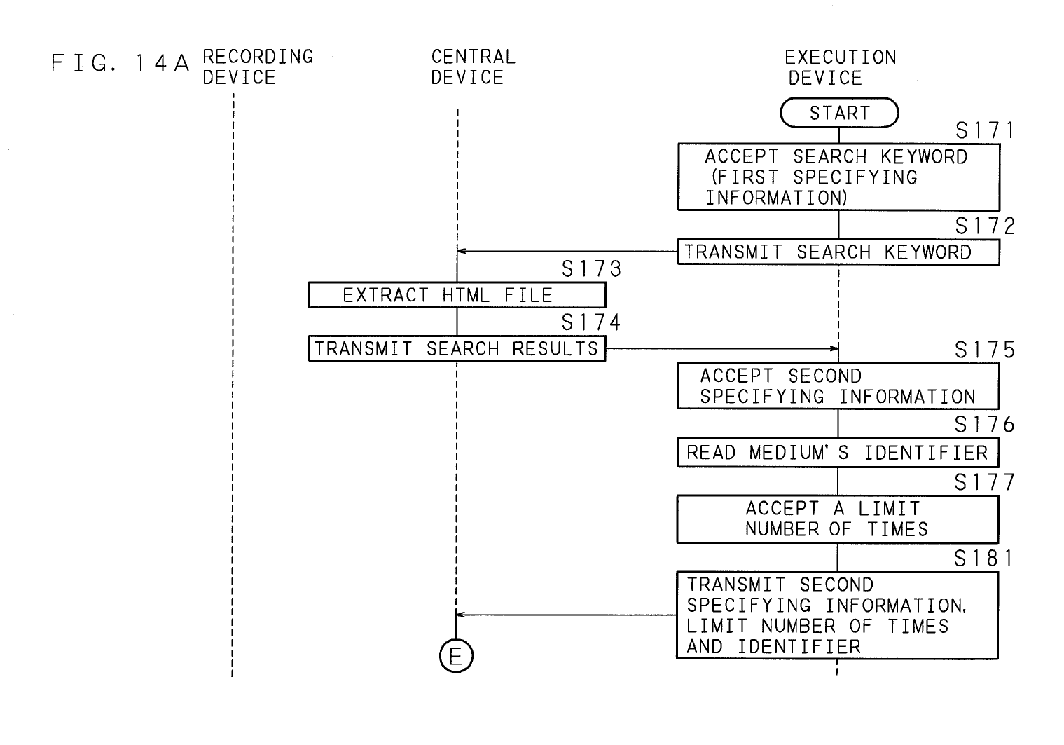

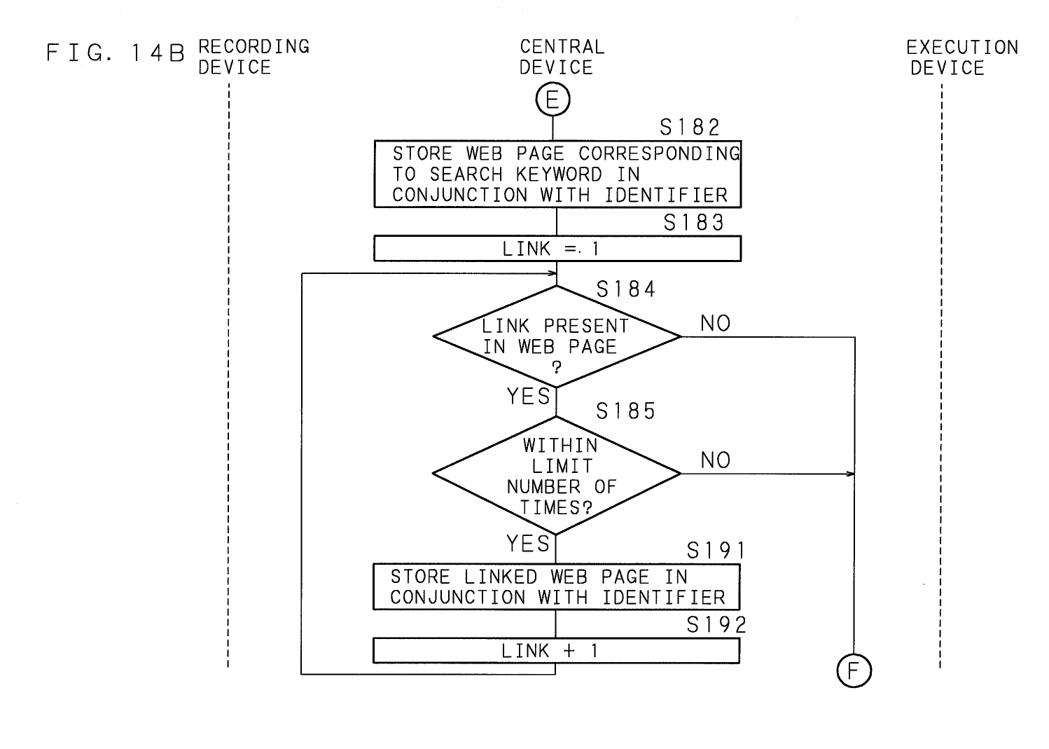

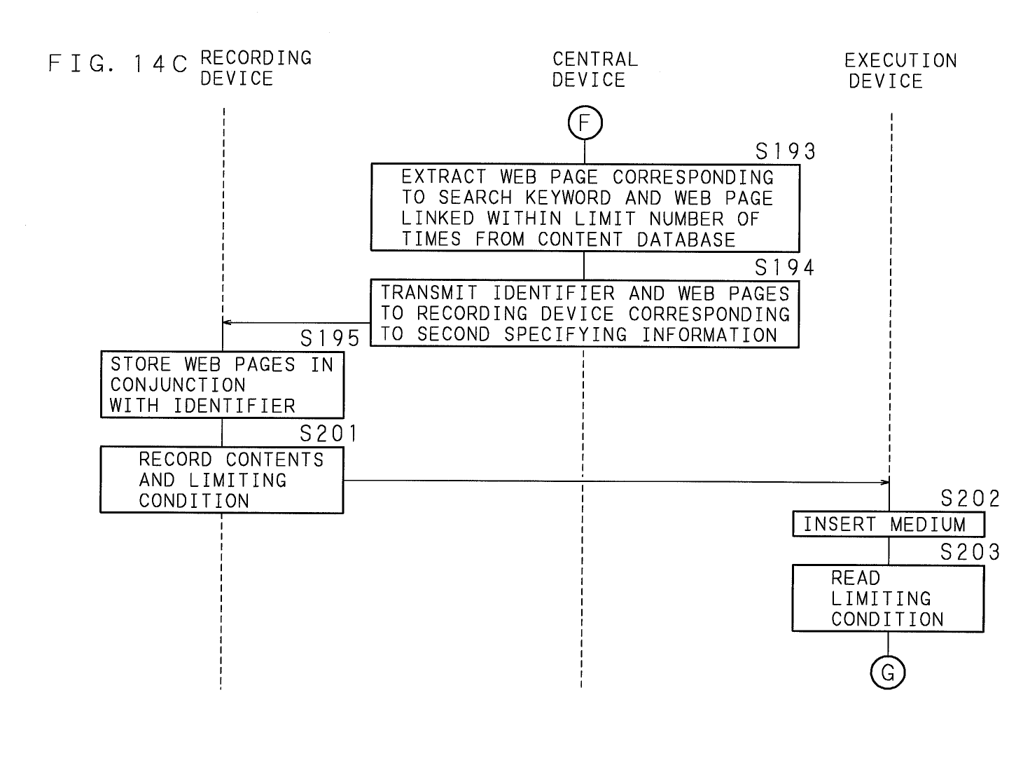

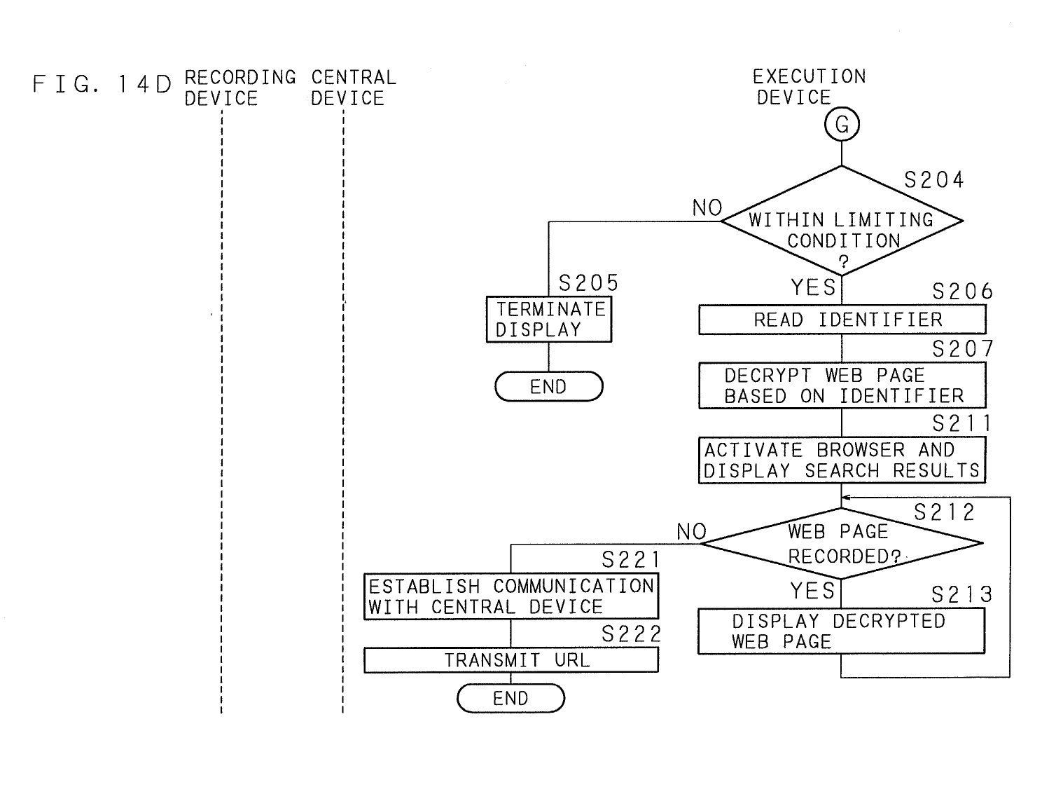

FIGS. 14A through 14D are flowcharts showing the processing procedure of the present invention according to Embodiment 2. First, the user activates a browser. The user inputs a search keyword from the web page of a search engine. The search keyword is accepted (step S171). The search keyword is transmitted to the central device 3 (step S172).

The central device 3 extracts an HTML file corresponding to the search keyword by referring to the web page DB 35a6 in the content database 35a (step S173). The central device 3 transmits to the execution device 2 the search results containing a link including a description and the URL of the hit web page (step S174). The execution device 2 accepts the second specifying information (step S175). Further, the execution device 2 reads the identifier of the medium M in the medium reader/writer 28 (step S176).

The user inputs a limit number of times for limiting the number of times of linking between the web page corresponding to the search keyword and the linked web pages. The inputted limit number of times is accepted by the execution device 2 (step S177). The accepted limit number of times, the second specifying information and the identifier are transmitted to the central device 3 (step S181).

The central device 3 downloads the web page corresponding to the search keyword. The central device 3 stores the downloaded web page in the content database 35a in conjunction with the identifier (step S182). Then, the central device 3 substitutes “1” for the array “link” (step S183).

The central device 3 judges whether a link for jumping to other page is present in the stored web page (step S184). If a link is present (YES in step S184), then the central device 3 judges whether linking is performed within the transmitted limit number of times (step S185). Here, when the linking does not exceed the transmitted limit number of times (YES in step S185), the central device 3 downloads the linked web page. The central device 3 stores the downloaded web page in the content database 35a in conjunction with the identifier (step S191).

Then, the central device 3 increments the array “link” (step S192). The central device 3 moves to step S184 again so as to repeat the above-described processes. Here, when a link is not present in the jumped web page in step S184 (NO in step S184) or if linking has already exceeded the transmitted limit number of times in step S185 (NO in step S185), the central device 3 moves to step S193. Then, the central device 3 extracts a web page corresponding to the stored search keyword and web pages linked within the limit number of times from the web page DB 35a6 in the content database 35a by using the identifier as a key (step S193).

The central device 3 transmits the identifier and the extracted web pages to the recording device 1 corresponding to the second specifying information (step S194). Note that the central device 3 may transmit the base prices to the recording device 1 at this time. Further, if the user transmits a limit number of times in step S181, then the central device 3 may transmit the base prices to the execution device 2. In this case, the base prices are suitably changed according to the number of times of linking.

The recording device 1 stores the contents, i.e., the web pages in the web page file 15a6 in the content file 15a in conjunction with the transmitted identifier (step S195).

The user brings the medium M to the recording device 1 and records the encrypted contents, limiting condition and so on. Note that since this process (step 201) is performed in the same manner as described in Embodiment 1, the contents of the processes performed in steps S114, S121 to S126 and S131 to S1313 will be omitted.

When the medium M on which the encrypted web pages and limiting condition are stored is inserted into the execution device 2 (step S202), the execution device 2 reads the limiting condition (step S203). The execution device 2 judges whether the read limiting condition satisfies the limiting condition (step S204).

In step S204, if the read limiting condition does not satisfy the limiting condition (NO in step S204), the execution device 2 ceases the display of the web page (step S205), and ejects the medium M.

On the other hand, if the read limiting condition satisfies the limiting condition (YES in step S204), the execution device 2 reads the identifier of the medium M (step S206). The execution device 2 decrypts the encrypted web page (content) based on this identifier and stores it in the RAM 22 (step S207). Then, the execution device 2 activates the browser. The execution device 2 displays a page showing the search results transmitted based on the process of step S174 (step S211).

Note that since a judgement as to whether the limiting condition is satisfied is made in the same manner as described in steps S143 to S1410 of Embodiment 1, the explanation thereof will be omitted.

Further, when the user clicks a link in the search results to perform web surfing, the execution device 2 judges whether the linked web page is recorded on the medium M (step S212). More specifically, the execution device 2 makes the judgement by comparing the URL recorded on the medium M or the decrypted URL in the RAM 22 with the linked URL. As a result, when the linked web page is recorded (YES in step S212), i.e., when the linked URL is recorded in the RAM 22, the decrypted web page corresponding to that URL is displayed on the browser (step S213).

On the other hand, when the web page is not recorded on the medium M (NO in step S212), i.e., the linked URL is not recorded in the decrypted form on the medium M or RAM 22, the execution device 2 establishes communications with the central device 3 (step S221). The execution device 2 transmits the linked URL to the central device 3 (step S222). The execution device 2 browses the web page. With the above-described structure, it is possible to record web pages by taking the recording capacity of the medium M into consideration. The user can browse web pages in an off-line state at a high speed.

Moreover, the web page producers are free from the problems that their web pages are abused by the third parties because the web pages can never be copied and are browsed under the limiting conditions. Furthermore, when a number of web pages exceeding a given number of times of linking are to be browsed, the present invention establishes communications so as to enable browsing of the linked web pages. It is therefore possible to meet the user's demand that he or she wishes to browse a number of web pages exceeding a given number of times of linking.

Embodiment 3

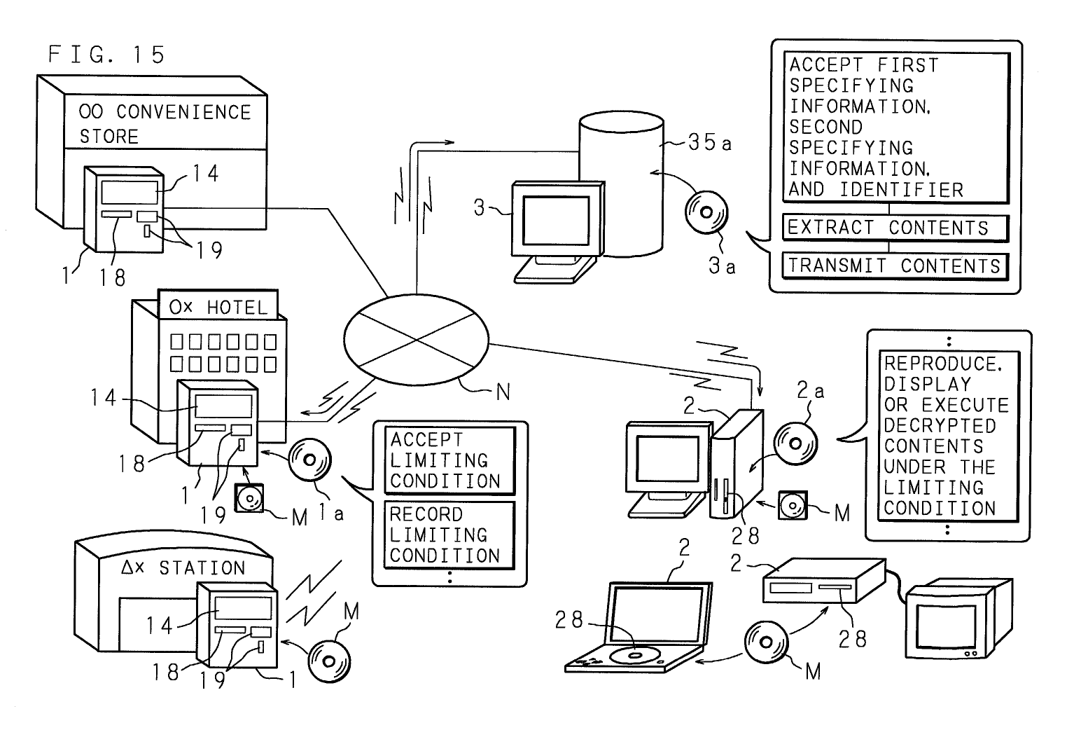

FIG. 15 is a schematic view showing an outline of the present invention according to Embodiment 3. A computer program for implementing the central device 3 according to Embodiments 1 and 2 can be supplied by pre-installing it in the central device 3 as described in Embodiment 3. Moreover, the computer program of the present invention can be supplied using a removable computer memory product such as a CD-ROM and MO. Further, the computer program can be supplied by propagating it as a carrier wave via a line. The following description will explain the contents.

Installed in the storage unit 35 of the central device 3 is a computer memory product 3a (CD-ROM, MO, DVD-ROM or the like) containing a program for causing the central device 3 shown in FIG. 15 to accept the first specifying information, second specifying information and identifier and to extract and transmit contents. This program is executed by loading it in the RAM 32 of the central device 3. Accordingly, the program functions as the central device 3 of the present invention as described above.

Besides, a computer program for implementing the execution device 2 according to Embodiments 1 and 2 can be supplied by pre-installing the program in the execution device 2 as described in Embodiment 3. Moreover, the computer program of the present invention can be supplied using a removable computer memory product such as a CD-ROM and MO. Further, the computer program can be supplied by propagating it as a carrier wave via a line. The following description will explain the contents.

Installed in the storage unit 25 of the execution device 2 is a computer memory product 2a (CD-ROM, MO, DVD-ROM or the like) containing a program for causing the execution device 2 shown in FIG. 15 to reproduce, display or execute decrypted contents under the limiting condition. This program is executed by loading it in the RAM 22 of the execution device 2. Accordingly, the program functions as the execution device 2 of the present invention as described above.

In addition, a computer program for implementing the recording device 1 according to Embodiments 1 and 2 can be supplied by pre-installing the program in the recording device 1 as described in Embodiment 3. Moreover, the computer program of the present invention can be supplied using a removable computer memory product such as a CD-ROM and MO. Further, the computer program can be supplied by propagating it as a carrier wave via a line. The following description will explain the contents.

Installed in the storage unit 15 of the recording device 1 is a computer memory product 1a (CD-ROM, MO, DVD-ROM or the like) containing a program for causing the recording device 1 shown in FIG. 15 to accept and record a limiting condition. This program is executed by loading it in the RAM 12 of the recording device 1. Accordingly, the program functions as the recording device 1 of the present invention as described above.

As this invention may be implemented in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1. A contents processing method comprising the steps of:
storing contents;
extracting the stored contents;
encrypting the extracted contents, based on an identifier given uniquely to a medium;
recording the encrypted contents on the medium;
accepting a limiting condition for reproducing, displaying or executing the contents;
recording the accepted limiting condition on the medium; and
reproducing, displaying or executing the contents recorded on the medium while decrypting the contents based on the identifier under the recorded limiting condition.

2. A contents processing system comprising:
a recording device for recording contents on a medium; and
an execution device for reproducing, displaying or executing the contents recorded on the medium,
wherein the recording device includes a processor capable of performing the following operations:
storing contents in advance in conjunction with first specifying information for specifying the contents;
accepting first specifying information; extracting the stored contents, based on the accepted first specifying information;
reading an identifier given uniquely to the medium;
encrypting the extracted contents, based on the read identifier;
recording the encrypted contents on the medium;
accepting a limiting condition for reproducing, displaying or executing the contents; and
recording the accepted limiting condition on the medium,
wherein the execution device includes a processor capable of performing the following operations:
reading the identifier of the medium; decrypting the contents recorded on the medium in an encrypted form, based on the read identifier; and
reproducing, displaying or executing the decrypted contents under the limiting condition recorded on the medium.

3. The contents processing system of claim 2, further comprising a central device connected to the recording device and the execution device via a communication network, wherein
the processor of the execution device is further capable of performing the following operations:
accepting first specifying information;
accepting second specifying information for specifying a recording device in which the contents are to be recorded; and
transmitting the accepted first specifying information, second specifying information and the identifier given to the medium to the central device, wherein
the central device includes a processor capable of performing the following operations:
extracting contents from a content database storing contents, based on the transmitted first specifying information; and
transmitting the extracted contents and the transmitted identifier to a recording device corresponding to the transmitted second specifying information, and
the processor of the recording device is further capable of performing the following operations:
storing the transmitted contents in the content file in conjunction with the identifier; and
extracting the contents from the content file based on the identifier of the medium.

4. The contents processing system of claim 3,
wherein the contents are web pages, and the first specifying information is a search keyword for searching for web pages, and
the processor of the central device extracts a web page corresponding to the transmitted search keyword and web pages linked to the web page from the content database, based on the search keyword, for extraction of the contents.

5. The contents processing system of claim 4,
wherein the processor of the central device is further capable of performing an operation of accepting a limit number of times for limiting the number of times of linking between the web page corresponding to the search keyword and web pages linked to the web page, and
the processor of the central device extracts the web page corresponding to the transmitted search keyword and web pages linked to the web page within the accepted limit number of times from the content database, based on the search keyword, for extraction of the contents.

6. The contents processing system of claim 5,
wherein the processor of the execution device is further capable of performing an operation of transmitting a URL of a web page which is not stored on the medium to the central device when the web page is to be displayed on a browser.

7. A recording device for recording contents on a medium, comprising a processor capable of performing the following operations:
storing the contents in advance in conjunction with first specifying information for specifying the contents;
accepting first specifying information;
accepting fees for recording the contents on the medium;
extracting the stored contents, based on the accepted first specifying information;
reading an identifier given uniquely to the medium;
encrypting the extracted contents, based on the read identifier; and
recording the encrypted contents on the medium.

8. A recording device for recording contents on a medium, comprising a processor capable of performing the following operations:
storing contents in advance in conjunction with first specifying information for specifying the contents;
accepting first specifying information;
extracting the stored contents, based on the accepted first specifying information;
reading an identifier given uniquely to the medium;
encrypting the extracted contents, based on the read identifier;
recording the encrypted contents on the medium;
accepting a limiting condition for reproducing, displaying or executing the contents; and
recording the accepted limiting condition on the medium.

9. The recording device of claim 8, wherein the processor is further capable of performing the following operations:
storing transmitted contents an d the identifier from the outside in a content file in conjunction with each other; and
extracting the contents from the content file, based on the identifier of the medium.

10. An execution device for reproducing, displaying or executing contents recorded on a medium, comprising:
a processor capable of performing the following operations:
reading an identifier given uniquely to the medium;
decrypting contents, which have been encrypted based on the identifier and recorded, based on the read identifier; and
reproducing, displaying or executing the decrypted contents under a limiting condition for reducing, displaying or executing the contents recorded on the medium.

11. The execution device of claim 10, wherein the processor is further capable of performing the following operations:
accepting first specifying information for specifying the contents;
accepting second specifying information for specifying other computer in which the contents are to be recorded; and
transmitting the accepted first specifying information and second specifying information and the read identifier of the medium to the outside.

12. A central device for transmitting contents to another computer connected via a communication network, comprising a processor capable of performing the following operations:
accepting first specifying information for specifying contents, second specifying information for specifying another computer in which the contents are to be recorded and an identifier given uniquely to each medium, transmitted from the outside;
extracting contents from a content database storing contents, based on the accepted first specifying information; and
transmitting the extracted contents and the identifier to another computer associated with the second specifying information.

13. The central device of claim 12,
wherein the contents are web pages and the first specifying information is a search keyword for searching for web pages, and
the processor extracts a web page corresponding to the transmitted search keyword and web pages linked to the web page from the content database, based on the search keyword, when the contents are to be extracted by the processor.

14. The central device of claim 13,
wherein the processor is further capable of performing an operation of accepting a limit number of times for limiting the number of times of linking between the web page corresponding to the search keyword and web pages linked to the web page, and
the processor extracts the web page corresponding to the transmitted search keyword and web pages linked to the web page within the accepted limit number of times from the content database, based on the search keyword, when the contents are to be extracted by the processor.

15. A contents processing system comprising:
a recording device for recording contents on a medium; and
an execution device for reproducing, displaying or executing the contents recorded on the medium,
wherein the recording device includes:
means for storing the contents in advance in conjunction with first specifying information for specifying the contents;
means for accepting first specifying information;
means for extracting the stored contents, based on the accepted first specifying information;
means for reading an identifier given uniquely to the medium;
means for encrypting the extracted contents, based on the read identifier;
means for recording the encrypted contents on the medium;
means for accepting a limiting condition for reproducing, displaying or executing the contents; and
means for recording the accepted limiting condition on the medium,
wherein the execution device includes:
means for reading the identifier of the medium;
means for decrypting contents recorded on the medium in an encrypted form, based on the read identifier; and
means for reproducing, displaying or executing the decrypted contents under the limiting condition recorded on the medium.

16. A recording device for recording contents on a medium, comprising:
means for storing the contents in advance in conjunction with first specifying information for specifying the contents;
means for accepting first specifying information;
means for accepting fees for recording the contents on the medium;
means for extracting the stored contents, based on the accepted first specifying information;
means for reading an identifier given uniquely to the medium;
means for encrypting the extracted contents, based on the read identifier; and
means for recording the encrypted contents on the medium.

17. An execution device for reproducing, displaying or executing contents recorded on a medium, comprising:
means for reading an identifier given uniquely to the medium;
means for decrypting contents, which have been encrypted based on the identifier and recorded, based on the read identifier; and
means for reproducing, displaying or executing the decrypted contents under a limiting condition for reproducing, displaying or executing the contents recorded on the medium.

18. A computer memory product readable by a computer and storing a computer program for recording contents on a medium, the computer program comprising the steps of:
storing the contents in advance in conjunction with first specifying information for specifying the contents;
accepting first specifying information;
extracting the stored contents, based on the accepted first specifying information;
reading an identifier given uniquely to the medium;
encrypting the extracted contents, based on the read identifier;
recording the encrypted contents on the medium;
accepting a limiting condition for reproducing, displaying or executing the contents; and
recording the accepted limiting condition on the medium.

19. A computer memory product readable by a computer and storing a computer program for reproducing, displaying or executing contents recorded on a medium, the computer program comprising the steps of:
reading an identifier given uniquely to the medium;
decrypting contents, which have been encrypted based on the identifier and recorded, based on the read identifier; and
reproducing, displaying or executing the decrypted contents under a limiting condition for reproducing, displaying or executing the contents recorded on the medium.

20. A computer memory product readable by a computer and storing a computer program for transmitting contents to another computer connected via a communication network, the computer program comprising the steps of:
accepting first specifying information for specifying contents, second specifying information for specifying another computer in which the contents are to be recorded, and an identifier given uniquely to each medium, transmitted from the outside;
extracting contents from a content database storing contents, based on the accepted first specifying information; and
transmitting the extracted contents and the identifier to another computer corresponding to the second specifying information.
